(19) United States
(12) Patent Application Publication
(10) Pub. No.: US 2024/0420502 A1
(43) Pub. Date: Dec. 19, 2024

(54) FACIAL IMAGE PROCESSING METHOD AND RELATED DEVICE

(71) Applicant: HUAWEI TECHNOLOGIES CO., LTD., Shenzhen, Guangdong (CN)

(72) Inventors: Cheng LI, Beijing (CN); Fenglong SONG, Beijing (CN); Ziluan LIU, Beijing (CN); Gang CHEN, Shenzhen (CN)

(21) Appl. No.: 18/799,194

(22) Filed: Aug. 9, 2024

Related U.S. Application Data
(63) Continuation of application No. PCT/CN2023/074538, filed on Feb. 6, 2023.

(30) Foreign Application Priority Data
Feb. 11, 2022 (CN) 202210130599.5

(51) Int. Cl. G06V 40/16; G06V 10/762; G06V 10/80; G06V 20/70

(52) U.S. Cl. CPC G06V 40/168; G06V 10/762; G06V 10/806; G06V 20/70

(57) ABSTRACT

Example facial image processing methods and apparatus are described. One example method includes obtaining a low-quality facial image and a first cluster label. A first target facial feature and a second target facial feature of the low-quality facial image are extracted. Each of P third target facial features is divided into R categories of first facial sub-features according to the first cluster label, where the P third target facial features are an output of a target convolutional neural network module of a face generator. An input that is of the target convolutional neural network module and that corresponds to the P third target facial features is obtained based on the first target facial feature. The first facial sub-features that are obtained through division are combined to obtain a first combined facial feature.

### CROSS-REFERENCE TO RELATED APPLICATIONS

This application is a continuation of International Application No. PCT/CN2023/074538, filed on Feb. 6, 2023, which claims priority to Chinese Patent Application No. 202210130599.5, filed on Feb. 11, 2022. The disclosures of the aforementioned applications are hereby incorporated by reference in their entireties.

### TECHNICAL FIELD

This application relates to the field of artificial intelligence technologies, and in particular, to a facial image processing method and a related device.

### BACKGROUND

Limited by performance of imaging hardware and performance of image signal processing (ISP) algorithms of electronic devices, quality of images captured currently is still not high enough. Especially, for key image content that users pay attention to such as faces, there are quality problems such as low resolution, lack of detail, and blur. In addition, when images are stored and transmitted, processings such as image compression, downsampling, and interpolation are usually performed on the images, further reducing quality of the images and especially further reducing quality of facial images in the images. In the field of consumer products, restoring quality of facial images is a quite urgent requirement. The restoration can greatly improve visual effect of faces, and helps increase accuracy of subsequent tasks such as face detection and recognition. However, conventional face restoration (or referred to as face enhancement) technologies have poor effect on improving quality of facial images, and still cannot meet the requirement.

### SUMMARY

Embodiments of this application disclose a facial image processing method and a related device, to improve quality of facial images.

According to a first aspect, an embodiment of this application provides a facial image processing method. The method includes: obtaining a low-quality facial image and a first cluster label; extracting features from the low-quality facial image, to obtain a first target facial feature and a second target facial feature; dividing each of P third target facial features into R categories of first facial sub-features according to the first cluster label, to obtain P first facial sub-feature sets, where any one of the P first facial sub-feature sets includes R categories of first facial sub-features, P is a positive integer, R is an integer greater than 1, the P third target facial features are an output of a target convolutional neural network module of a face generator, and an input that is of the target convolutional neural network module and that corresponds to the P third target facial features is obtained based on the first target facial feature; combining the first facial sub-features in the P first facial sub-feature sets based on the second target facial feature and the first cluster label, to obtain a first combined facial feature; and obtaining a first synthetic facial image based on the first combined facial feature. Dimensions of the first target facial feature are different from dimensions of the second target facial feature. Optionally, the dimensions of the first target facial feature are less than the dimensions of the second target facial feature, and the dimensions of the second target facial feature are the same as dimensions of the first facial sub-feature. The P third target facial features correspond to the P first facial sub-feature sets. A first facial sub-feature set corresponding to any one of the P third target facial features includes R categories of first facial sub-features that are obtained through division of the any third target facial feature. It should be noted that the target convolutional neural network module may have a plurality of inputs, and the input of the target convolutional neural network module obtained based on the first target facial feature may be a part of all inputs of the target convolutional neural network module.

In this embodiment of this application, for a low-quality facial image, features are extracted from the facial image, to obtain a first target facial feature and a second target facial feature of the low-quality facial image. Based on the first target facial feature, an input of the target convolutional neural network module of the face generator is obtained. Based on the input, the target convolutional neural network module may output P third target facial features. Then, each of the P third target facial features is divided into R categories of first facial sub-features according to a first cluster label. In this way, P first facial sub-feature sets are obtained. Any first facial sub-feature set includes R categories of first facial sub-features. Then, based on the second target facial feature and the first cluster label, the first facial sub-features in the P first facial sub-feature sets are combined, to obtain a first combined facial feature. Finally, an enhanced first synthetic facial image can be obtained based on the first combined facial feature. For example, the first combined facial feature is input into a subsequent module that is connected to the target convolutional neural network module and that is in the face generator for processing, and an enhanced, high-quality first synthetic facial image is finally output. It should be understood that a third target facial feature constitutes a face synthesis feature space. After the third target facial feature is divided into R categories of first facial sub-features, each category of first facial sub-features of the R categories of first facial sub-features constitute a face synthesis feature subspace. Therefore, the R categories of first facial sub-features constitute R face synthesis feature subspaces, respectively. In addition, because there are P first facial sub-feature sets and each of the P first facial sub-feature sets includes R categories of first facial sub-features, each face synthesis feature subspace includes P first facial sub-features. To be specific, each face synthesis feature subspace includes a plurality of facial prior sub-features. Moreover, the first facial sub-features in the P first facial sub-feature sets are combined to obtain a first combined facial feature, that is, the plurality of facial prior sub-features in the face synthesis feature subspaces are fused to obtain a facial prior feature that is more effective. Therefore, a first synthetic facial image restored based on the first combined facial feature is an enhanced facial image. In this way, in this embodiment of this application, a face synthesis feature space is divided into subspaces, a plurality of facial prior sub-features in each face synthesis feature subspace are obtained, the plurality of facial prior sub-features in the face synthesis feature subspaces are then combined to obtain a facial prior feature that is more effective, and face restoration (or face enhancement) is then performed based on the facial prior feature that is obtained through combination, implementing leveraging of the facial prior feature during face restoration. This can not only improve quality of a facial image (for example, restoring naturalness of details), but also ensure that facial attributes (for example, a face identity, a facial posture, and other information) are authentic and unchanged.

In a possible implementation, the P third target facial features are obtained by performing convolutional modulation on the target convolutional neural network module based on the first target facial feature and P first random vectors. The P third target facial features correspond to the P first random vectors.

In this implementation, convolutional modulation is performed on the target convolutional neural network module based on the first target facial feature and the P first random vectors, to obtain the P third target facial features. To be specific, the P third target facial features are an output that is obtained after convolutional modulation is performed on the target convolutional neural network module. By performing convolutional modulation on the target convolutional neural network module, a weight of a convolutional kernel in the target convolutional neural network module can be corrected. Therefore, when face restoration is performed based on the P third target facial features that are output after convolutional modulation is performed on the target convolutional neural network module, it can be ensured that facial attributes are authentic and unchanged during face restoration while quality of the facial image is improved.

In a possible implementation, the P third target facial features are obtained by performing convolutional modulation on the target convolutional neural network module based on P target style vectors, and the P target style vectors are obtained based on the first target facial feature and the P first random vectors. The P third target facial features correspond to the P target style vectors, and the P target style vectors correspond to the P first random vectors.

In this implementation, the face generator (or the target convolutional neural network module) implements control based on style vectors. For example, the P target style vectors are obtained based on the first target facial feature and the P first random vectors. Then, convolutional modulation is performed on the target convolutional neural network module based on the P target style vectors, to obtain the P third target facial features. Finally, face restoration is performed based on the P third target facial features. In this way, controllability, diversity, and robustness of the facial prior feature can be improved, and the facial prior feature is fully leveraged during face restoration, improving face restoration capabilities (for example, restoring more details of a facial image) and generalization abilities of the face generator.

In a possible implementation, the P target style vectors are obtained based on P first concatenated vectors, the P first concatenated vectors are obtained by concatenating a first feature vector to each of the P first random vectors, and the first feature vector is obtained based on the first target facial feature. The P target style vectors correspond to the P first concatenated vectors, and the P first concatenated vectors correspond to the P first random vectors.

In this implementation, first, the first target facial feature is converted into the first feature vector. Then, the first feature vector is concatenated to each of the P first random vectors, to obtain the P first concatenated vectors. Then, the P target style vectors are obtained based on the P first concatenated vectors. For example, the P first concatenated vectors are input into a first fully connected layer, to obtain the P target style vectors. In this way, the P target style vectors can be obtained based on the first target facial feature and the P first random vectors, helping the face generator (or the target convolutional neural network module) implement control based on style vectors.

In a possible implementation, the combining the first facial sub-features in the P first facial sub-feature sets based on the second target facial feature and the first cluster label, to obtain a first combined facial feature includes: obtaining P first combined weight sets based on the second target facial feature and the P first facial sub-feature sets, where the P first combined weight sets correspond to the P first facial sub-feature sets, any one of the P first combined weight sets includes R first combined weights, the R first combined weights correspond to R categories of first facial sub-features in a first target facial sub-feature set, the first target facial sub-feature set is a first facial sub-feature set that corresponds to the any first combined weight set and that is of the P first facial sub-feature sets, and any one of the R first combined weights is obtained based on the second target facial feature and a first facial sub-feature that is in a category corresponding to the any first combined weight and that is in the first target facial sub-feature set; and combining the first facial sub-features in the P first facial sub-feature sets based on the first cluster label and the P first combined weight sets, to obtain the first combined facial feature. The any first combined weight is obtained by performing convolution and pooling operations on a first concatenated feature. An output of a convolution operation is an input of a pooling operation. The first concatenated feature is obtained by concatenating the second target facial feature and the first facial sub-feature corresponding to the any first combined weight.

In this implementation, a first combined weight corresponding to each first facial sub-feature is obtained based on the second target facial feature and each first facial sub-feature. For example, the second target facial feature is concatenated to each first facial sub-feature, and then convolution and pooling operations are performed on a result that is obtained after the second target facial feature is concatenated to each first facial sub-feature, to obtain the first combined weight corresponding to each first facial sub-feature. Then, the first facial sub-features are combined based on the first cluster label and the first combined weight corresponding to each first facial sub-feature, to obtain the first combined facial feature. In this way, because the first combined weight corresponding to each first facial sub-feature is obtained based on the second target facial feature and the first facial sub-feature, it can be ensured that the first combined facial feature obtained through combination is a facial prior feature that is more effective.

In a possible implementation, the combining the first facial sub-features in the P first facial sub-feature sets based on the first cluster label and the P first combined weight sets, to obtain the first combined facial feature includes: obtaining P second facial sub-feature sets based on the P first facial sub-feature sets and the P first combined weight sets, where the P first facial sub-feature sets correspond to the P second facial sub-feature sets, any one of the P second facial sub-feature sets includes R categories of second facial sub-features, the R categories of second facial sub-features correspond to R categories of first facial sub-features in a second target facial sub-feature set, the second target facial sub-feature set is a first facial sub-feature set that corresponds to the any second facial sub-feature set and that is of the P first facial sub-feature sets, a second facial sub-feature in any category of the R categories of second facial sub-features is obtained by multiplying a first target facial sub-feature by a first target combined weight, the first target facial sub-feature is a first facial sub-feature that is in a category corresponding to the any category of second facial sub-features, and the first target combined weight is a first combined weight corresponding to the first target facial sub-feature; adding up second facial sub-features that are in a same category in the P second facial sub-feature sets, to obtain R third facial sub-features; multiplying the first cluster label by each of the R third facial sub-features, to obtain R fourth facial sub-features; and combining the R fourth facial sub-features, to obtain the first combined facial feature.

In this implementation, each first facial sub-feature in the P first facial sub-feature sets is multiplied by a first combined weight corresponding to the first facial sub-feature, to obtain a second facial sub-feature corresponding to each first facial sub-feature. Because there are R categories of first facial sub-features, there are R categories of second facial sub-features. Each of the R categories has P second facial sub-features. Of the R categories of second facial sub-features, second facial sub-features in a category are added up, to obtain the R third facial sub-features. The first cluster label is multiplied by each of the R third facial sub-features, to obtain the R fourth facial sub-features. The R fourth facial sub-features are combined, to obtain the first combined facial feature. In this way, the first facial sub-features in the P first facial sub-feature sets can be combined to obtain the first combined facial feature.

In a possible implementation, the first cluster label is obtained by performing one-hot encoding on a second cluster label, the second cluster label is obtained by processing a similarity matrix using a preset clustering method, the similarity matrix is obtained based on a first self-expressive matrix, the first self-expressive matrix is obtained by training a second self-expressive matrix based on a plurality of first facial features, the plurality of first facial features are obtained after a plurality of second random vectors are input into the face generator separately, and the plurality of first facial features are an output of the target convolutional neural network module. The plurality of first facial features correspond to the plurality of second random vectors.

In this implementation, the first cluster label is obtained by performing one-hot encoding on the second cluster label, the second cluster label is obtained by processing the similarity matrix using the preset clustering method, the similarity matrix is obtained based on the first self-expressive matrix, and the first self-expressive matrix is obtained through training. In this way, the first cluster label is obtained through training, facilitating division of the third target facial feature.

In a possible implementation, the first self-expressive matrix is obtained by performing the following operations, and for the plurality of first facial features, the following operations are performed, to obtain the first self-expressive matrix: S11: multiplying a fourth target facial feature by a first target self-expressive matrix, to obtain a fourth facial feature, where the fourth target facial feature is one of the plurality of first facial features; S12: obtaining a second synthetic facial image based on the fourth facial feature; S13: obtaining a first loss based on the fourth target facial feature and the second synthetic facial image; S14: if the first loss is less than a first preset threshold, using the first target self-expressive matrix as the first self-expressive matrix, or if the first loss is not less than a first preset threshold, adjusting an element in the first target self-expressive matrix based on the first loss to obtain a second target self-expressive matrix, and performing step S15; and S15: continuing to perform step S11 to step S14 with a fifth target facial feature as the fourth target facial feature and the second target self-expressive matrix as the first target self-expressive matrix, where the fifth target facial feature is a first facial feature that is not used for training yet and that is of the plurality of first facial features, and when step S11 is performed for the first time, the first target self-expressive matrix is the second self-expressive matrix.

In this implementation, the second self-expressive matrix is trained iteratively using the plurality of first facial features output by the face generator, that is, the second self-expressive matrix is optimized to obtain the first self-expressive matrix. This helps obtain an appropriate second cluster label and further obtain an appropriate first cluster label.

According to a second aspect, an embodiment of this application provides a facial image processing apparatus. The apparatus includes a processing unit, configured to: obtain a low-quality facial image and a first cluster label; extract features from the low-quality facial image, to obtain a first target facial feature and a second target facial feature; divide each of P third target facial features into R categories of first facial sub-features according to the first cluster label, to obtain P first facial sub-feature sets, where any one of the P first facial sub-feature sets includes R categories of first facial sub-features, P is a positive integer, R is an integer greater than 1, the P third target facial features are an output of a target convolutional neural network module of a face generator, and an input that is of the target convolutional neural network module and that corresponds to the P third target facial features is obtained based on the first target facial feature; combine the first facial sub-features in the P first facial sub-feature sets based on the second target facial feature and the first cluster label, to obtain a first combined facial feature; and obtain a first synthetic facial image based on the first combined facial feature.

In a possible implementation, the P third target facial features are obtained by performing convolutional modulation on the target convolutional neural network module based on the first target facial feature and P first random vectors.

In a possible implementation, the P third target facial features are obtained by performing convolutional modulation on the target convolutional neural network module based on P target style vectors, and the P target style vectors are obtained based on the first target facial feature and the P first random vectors.

In a possible implementation, the P target style vectors are obtained based on P first concatenated vectors, the P first concatenated vectors are obtained by concatenating a first feature vector to each of the P first random vectors, and the first feature vector is obtained based on the first target facial feature.

In a possible implementation, the processing unit is specifically configured to: obtain P first combined weight sets based on the second target facial feature and the P first facial sub-feature sets, where the P first combined weight sets correspond to the P first facial sub-feature sets, any one of the P first combined weight sets includes R first combined weights, the R first combined weights correspond to R categories of first facial sub-features in a first target facial sub-feature set, the first target facial sub-feature set is a first facial sub-feature set that corresponds to the any first combined weight set and that is of the P first facial sub-feature sets, and any one of the R first combined weights is obtained based on the second target facial feature and a first facial sub-feature that is in a category corresponding to the any first combined weight and that is in the first target facial sub-feature set; and combine the first facial sub-features in the P first facial sub-feature sets based on the first cluster label and the P first combined weight sets, to obtain the first combined facial feature.

In a possible implementation, the processing unit is specifically configured to: obtain P second facial sub-feature sets based on the P first facial sub-feature sets and the P first combined weight sets, where the P first facial sub-feature sets correspond to the P second facial sub-feature sets, any one of the P second facial sub-feature sets includes R categories of second facial sub-features, the R categories of second facial sub-features correspond to R categories of first facial sub-features in a second target facial sub-feature set, the second target facial sub-feature set is a first facial sub-feature set that corresponds to the any second facial sub-feature set and that is of the P first facial sub-feature sets, a second facial sub-feature in any category of the R categories of second facial sub-features is obtained by multiplying a first target facial sub-feature by a first target combined weight, the first target facial sub-feature is a first facial sub-feature that is in a category corresponding to the any category of second facial sub-features, and the first target combined weight is a first combined weight corresponding to the first target facial sub-feature; add up second facial sub-features that are in a same category in the P second facial sub-feature sets, to obtain R third facial sub-features; multiply the first cluster label by each of the R third facial sub-features, to obtain R fourth facial sub-features; and combine the R fourth facial sub-features, to obtain the first combined facial feature.

In a possible implementation, the first cluster label is obtained by performing one-hot encoding on a second cluster label, the second cluster label is obtained by processing a similarity matrix using a preset clustering method, the similarity matrix is obtained based on a first self-expressive matrix, the first self-expressive matrix is obtained by training a second self-expressive matrix based on a plurality of first facial features, the plurality of first facial features are obtained after a plurality of second random vectors are input into the face generator separately, and the plurality of first facial features are an output of the target convolutional neural network module.

In a possible implementation, the first self-expressive matrix is obtained by performing the following operations, and for the plurality of first facial features, the following operations are performed, to obtain the first self-expressive matrix: S11: multiplying a fourth target facial feature by a first target self-expressive matrix, to obtain a fourth facial feature, where the fourth target facial feature is one of the plurality of first facial features; S12: obtaining a second synthetic facial image based on the fourth facial feature; S13: obtaining a first loss based on the fourth target facial feature and the second synthetic facial image; S14: if the first loss is less than a first preset threshold, using the first target self-expressive matrix as the first self-expressive matrix, or if the first loss is not less than a first preset threshold, adjusting an element in the first target self-expressive matrix based on the first loss to obtain a second target self-expressive matrix, and performing step S15; and S15: continuing to perform step S11 to step S14 with a fifth target facial feature as the fourth target facial feature and the second target self-expressive matrix as the first target self-expressive matrix, where the fifth target facial feature is a first facial feature that is not used for training yet and that is of the plurality of first facial features, and when step S11 is performed for the first time, the first target self-expressive matrix is the second self-expressive matrix.

It should be noted that for beneficial effects of the second aspect, reference may be made to descriptions of the first aspect. Details are not described herein again.

According to a third aspect, an embodiment of this application provides an electronic device. The electronic device includes a processor, a memory, a transceiver, and one or more programs. The one or more programs are stored in the memory and configured to be executed by the processor. The program includes instructions used to perform steps in the method according to any one of the implementations in the foregoing first aspect.

According to a fourth aspect, an embodiment of this application provides a chip.

The chip includes a processor. The processor is configured to invoke a computer program from a memory and run the computer program, so that a device on which the chip is installed performs the method according to any one of the implementations in the foregoing first aspect.

According to a fifth aspect, an embodiment of this application provides a computer-readable storage medium. The computer-readable storage medium stores a computer program that is used for exchange of electronic data. The computer program enables a computer to perform the method according to any one of the implementations in the foregoing first aspect.

According to a sixth aspect, an embodiment of this application provides a computer program product. The computer program product enables a computer to perform the method according to any one of the implementations in the foregoing first aspect.

### BRIEF DESCRIPTION OF DRAWINGS

The following describes accompanying drawings used in embodiments of this application.

FIG. 1 is a schematic diagram of a structure of a face generator that is based on a generative adversarial network (GAN) according to an embodiment of this application;

FIG. 2 is a schematic diagram of a structure of the generative adversarial network module shown in FIG. 1;

FIG. 3 is a schematic diagram of a structure of a face restoration network that is based on the face generator shown in FIG. 1;

FIG. 4 is a schematic diagram of a comparison between face restoration solutions;

FIG. 5 is a schematic diagram of a structure of a system architecture according to an embodiment of this application;

FIG. 6 is a schematic flowchart of a facial image processing method according to an embodiment of this application;

FIG. 7 is a schematic flowchart of facial image processing data according to an embodiment of this application;

FIG. 8 is a schematic diagram of training phases of a face restoration network according to an embodiment of this application;

FIG. 9 is a schematic diagram of an inference phase of the face restoration network shown in FIG. 8;

FIG. 10A and FIG. 10B are schematic diagrams of training phases of an example structure of the face restoration network shown in FIG. 8;

FIG. 11 is a schematic diagram of an inference phase of the face restoration network shown in FIG. 10A and FIG. 10B;

FIG. 12 is a schematic diagram of a structure of a facial image processing apparatus according to an embodiment of this application;

FIG. 13 is a schematic diagram of a structure of an electronic device according to an embodiment of this application; and

FIG. 14 is a schematic diagram of a structure of a computer program product according to an embodiment of this application.

### DESCRIPTION OF EMBODIMENTS

To enable persons skilled in the art to better understand solutions in this application, the following clearly and describes the technical solutions in embodiments of this application with reference to accompanying drawings in embodiments of this application. It is clear that the described embodiments are merely some but not all of embodiments of this application. All other embodiments obtained by persons of ordinary skill in the art based on embodiments of this application without creative efforts fall within the protection scope of this application.

Terms “include”, “have”, and any variant thereof in the specification, claims, and the accompanying drawings of this application, are intended to cover non-exclusive inclusions. For example, a process, method, system, product, or device that includes a series of steps or units is not limited to listed steps or units, but optionally further includes an unlisted step or unit, or optionally further includes another step or unit inherent in the process, method, product, or device.

An “embodiment” mentioned in the specification means that a particular characteristic, structure, or feature described with reference to the embodiment may be included in at least one embodiment of this application. The “embodiments” occurring in various places in the specification neither necessarily all represent a same embodiment nor are separate or alternative embodiments that are mutually exclusive to other embodiments. It is explicitly and implicitly understood by persons skilled in the art that embodiments described in the specification may be combined with other embodiments.

First, some of technical terms in this application are explained, to help persons skilled in the art understand this application.
(1) Peak signal-to-noise ratio (PSNR): A peak signal-to-noise ratio is an engineering term for a ratio between a maximum possible power of a signal and a power of corrupting noise that affects fidelity of its representation. The peak signal-to-noise ratio is often used as a measure of quality of signal reconstruction in fields such as image processing, and usually is simply defined by mean squared error.
(2) Structural similarity index (SSIM): A structural similarity index is a metric measuring similarity between two images, and is used to evaluate quality of an output image processed by an algorithm. The structural similarity index defines, from a perspective of image composition, structural information as an attribute that reflects a structure of an object in a scene and that is independent of luminance and contrast, and models distortion as a combination of three different factors of luminance, contrast, and structure. The structural similarity index uses a mean as an estimate of luminance, a standard deviation as an estimate of contrast, and a covariance as a measure of structural similarity.
(3) Learned perceptual image patch similarity (LPIPS): Learned perceptual image patch similarity is used to measure a difference between two images. The metric learns reverse mappings from a generated image to a truth image. A generator is forced to learn reverse mappings that reconstruct a real image from a fake image, and to prioritize processing of perceptual similarity between the real image and the fake image. A smaller learned perceptual image patch similarity value indicates that two images are more similar, whereas a larger learned perceptual image patch similarity value indicates that two images differ more greatly.
(4) Natural image quality evaluator (NIQE): A natural image quality evaluator is a no-reference evaluation metric measuring quality of an image. Features of a natural scene are extracted for testing of a to-be-tested image. These features are fit to form a multivariate Gaussian model. The Gaussian model actually measures differences of a to-be-tested image in a multivariate distribution. The multivariate distribution is constructed from a series of features extracted from a normal natural image.
(5) Fréchet inception distance (FID): A Fréchet inception distance is an objective metric used to evaluate quality of an image created by a generative model. Similarity between two images is measured based on statistical similarity between computer visual features of images. The computer visual features are obtained through computation that is performed using an image classification model that is based on a convolutional neural network (CNN). A smaller Fréchet inception distance indicates that two groups of images are more similar.
(6) Face restoration (also referred to as face enhancement): Face restoration is a technology of processing a color, a texture, and the like of an image including a face to meet specific metrics.
(7) Artifacts: In an image quality enhancement task, an obvious error or exception occurs in an image enhanced by a neural network. The error or exception includes a case in which an obviously incorrect color or an obviously erroneous image detail appears in a region that should have a correct color and natural details, and the like.
(8) Face generator (Face Generator): A face generator is a generative model that is based on a neural network. After random vectors or fixed vectors are input into the face generator, the face generator can output a realistic, natural, high-quality facial image. A face synthesis feature space is a space including face synthesis features (also referred to as face generator features), that is, a feature space including all the face generator features. The face generator is a multi-layer convolutional neural network. The face synthesis features are feature tensors at various layers generated after convolution operations are performed in the convolutional neural network.
(9) Style vector: A style vector is an intermediate generated variable that is common in some generative networks, and is a vector used to scale a weight of a convolutional kernel.

Second, some problems existing in application of a deep learning method to a face restoration task are analyzed, to help understand this application.

The deep learning method, especially the method that is based on a convolutional neural network, has achieved the industry's good performance in the field of image restoration and enhancement, gradually surpassing conventional algorithms. However, when the deep learning method is applied to a face restoration task, there are still some urgent problems to be resolved. The following provides a specific analysis.
(1) Facial prior knowledge is not fully leveraged. There is a great deal of facial prior knowledge (for example, a structure of a face is relatively fixed, and positions of facial features remain unchanged relative to each other). However, a large quantity of existing universal image enhancement and super-resolution methods that are based on a convolutional neural network do not leverage the facial prior knowledge, resulting in occurrence of problems such as poor facial detail restoration, many artifacts, and poor enhancement effect.
(2) A convolutional neural network model has poor generalization abilities. In real application scenarios, quality of a facial image that is obtained after capturing, image processing, and transmission are performed degrades in complex and varied manners. A convolutional neural network model obtained through training that is performed based on limited data cannot effectively restore facial images that degrade to different degrees. Therefore, the convolutional neural network model cannot adapt to open and diverse scenarios.
(3) Face restoration methods based on a convolutional neural network have performance problems such as a large delay, occupation of large storage space, and high power consumption. Some methods combine conventional algorithms with the deep learning method and use the facial prior knowledge in a manner of dictionary matching. However, these methods target only specific facial features, are severely affected by a facial posture and lighting, and have disadvantages of a long online matching time and high memory consumption. In addition, some methods use a face generator and map an input low-quality face image to a face synthesis feature space, to obtain valid face synthesis features and restore a facial image. However, a synthetic face and a real face have inconsistent distributions. It is quite difficult to obtain features matching an input in the face synthesis feature space, resulting in problems such as a face identity change and obvious artifacts.

Based on the above analysis, it is urgent to provide a more effective and more adequate manner of leveraging facial prior knowledge and design a full-scenario, high-quality, and efficient face restoration solution for real-world scenarios and unknown complex degradation.

Third, for ease of understanding embodiments of this application, the following describes examples of several conventional technical solutions to face restoration.

Conventional Technical Solution 1: Convolutional Neural Network that is Based on General Image Enhancement

A core idea of a face enhancement method using a convolutional neural network that is based on general image enhancement is simple. A network structure includes N concatenated N convolutional layers. A network output is K (K≥1) times an input in size. In addition, details and textures of a final output are enhanced using a visual perceptual loss and an adversarial loss. The method does not leverage facial prior knowledge, resulting in occurrence of problems such as inadequate restoration of facial details, many artifacts, and poor restoration effect.

Conventional Technical Solution 2: Convolutional Neural Network that is Based on Offline Dictionary Matching

A core idea of a face enhancement method using a convolutional neural network that is based on offline dictionary matching is as follows: In a face dictionary generation phase, Visual Geometry Group Network (VGG) features of high-quality facial images are extracted, and a feature dictionary of facial feature regions of faces is generated offline. In a face restoration phase, by using a true value Unet (Ground Truth) structure, VGG features of a quality-degraded facial image are extracted, and matched in the generated feature dictionary to correct features of facial feature positions, to finally obtain a restored face. The method has a number of drawbacks. First, only a dictionary for some facial organs can be generated, and effect of restoring hair, skin, and other regions is poor. Second, dictionary loading and online matching is time-consuming and memory resource-consuming. In addition, being based on a conventional matching method, the method is not robust enough, and a change in a facial posture and lighting severely affects effect of the method.

Conventional Technical Solution 3: Convolutional Neural Network that is Based on a Face Generator

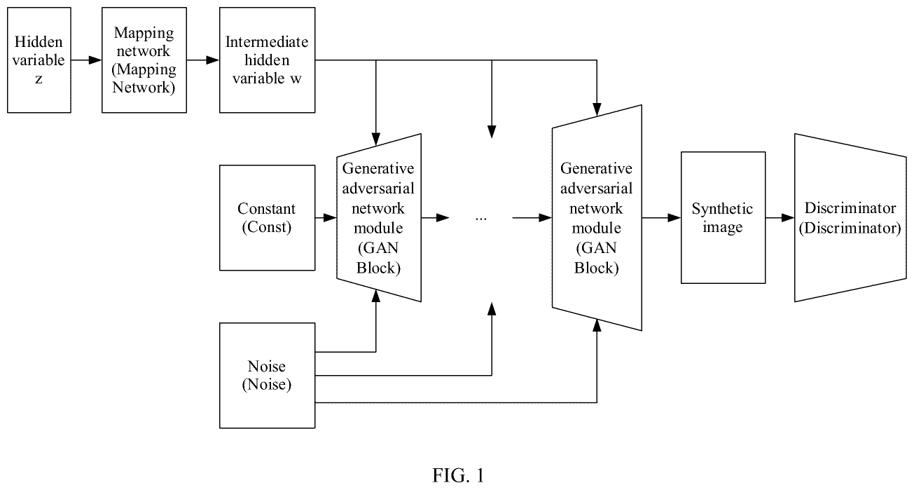

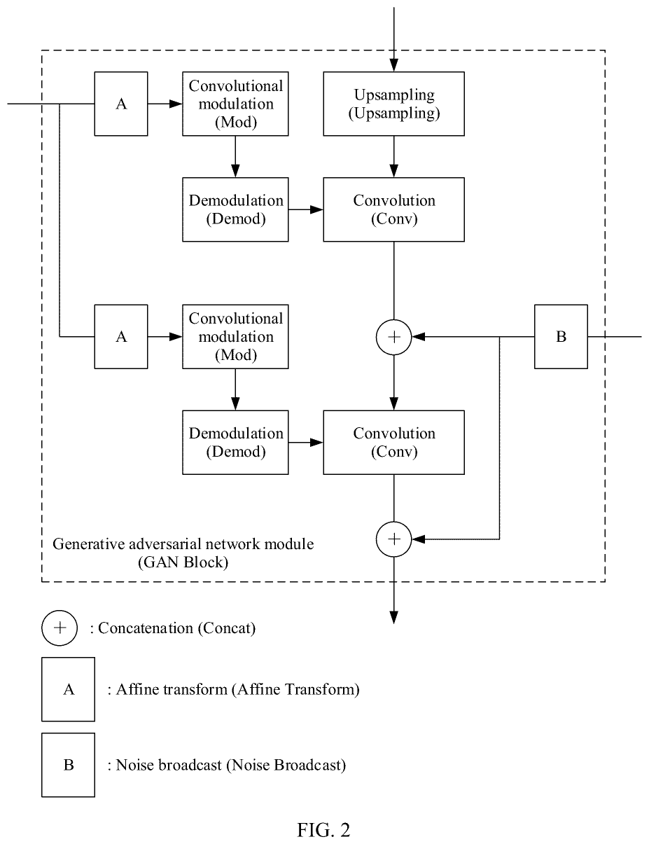

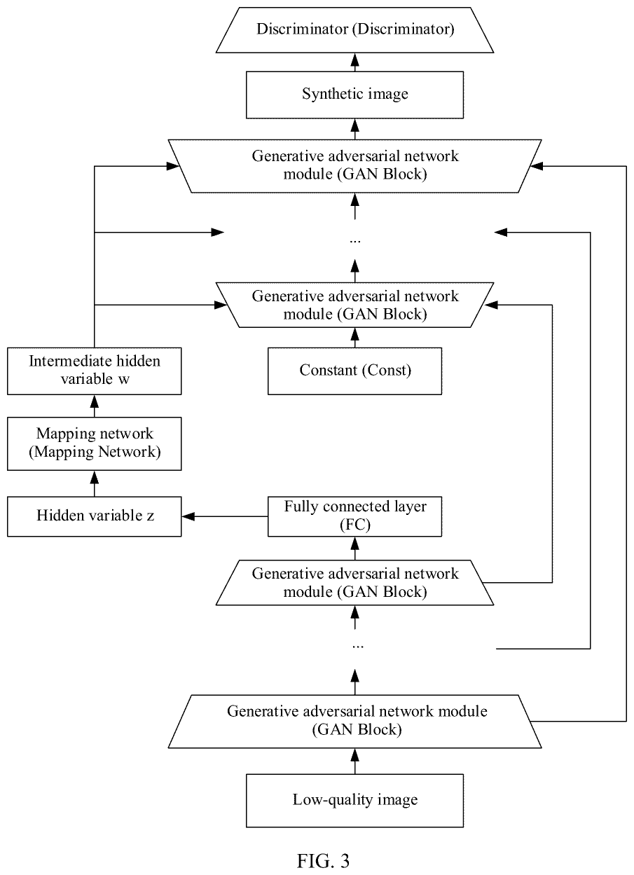

A face enhancement method using a convolutional neural network that is based on a face generator belongs to latest technology trends. FIG. 1 is a schematic diagram of a structure of a face generator that is based on a generative adversarial network. A network structure of the face generator includes a mapping network (network M for short) and generative adversarial network modules (GAN Block, network G for short). The network M is configured to generate an intermediate hidden variable w based on a hidden variable z. ω is used to control a style of a synthetic image. The hidden variable z is a random vector z that follows a Gaussian distribution. The networks G are configured to generate a synthetic image. As shown in FIG. 2, the generative adversarial network module inputs A and B to each layer of sub-network. A is an affine transform obtained by converting ω and is used to control a style of a generated image. B is a random noise broadcast obtained through conversion. Random noise is used to enrich the generated image with details. To be specific, each convolutional layer can adjust a style based on the input A. As shown in FIG. 3, a core idea of the method is as follows: A face generator is pre-trained, a degraded face is then input into a feature extraction module, and the face generator is controlled using extracted features to obtain a generated face as a final restoration result. Network parameters of the face generator may change in this process. The method has a number of drawbacks. First, a generated face and a real face have inconsistent distributions, and it is difficult to effectively leverage face synthesis features. Second, it is quite difficult to map a face undergoing a complex degradation process to a face synthesis feature space, resulting in changes in an identity and other information of a finally restored face. In addition, manners of leveraging and fusing face synthesis features are simple and need to be further optimized.

Considering that the face restoration solutions provided by conventional technologies have a problem of being difficult to leverage facial prior knowledge and a problem of face synthesis features not fully leveraged, an embodiment of this application provides a face restoration solution that is based on multi-subspace prior synthesis.

Specifically, in view of the problem of being difficult to leverage facial prior knowledge existing in the current face restoration method, a face restoration network framework based on multi-mapping of face synthesis feature subspaces is designed in this application. A face synthesis feature space is divided into subspaces to obtain a plurality of facial prior features in each subspace. The plurality of facial prior features are finally fused to obtain a facial prior feature that is more effective. While improving quality of face restoration, this ensures that a face identity, a facial posture, and other information are authentic and unchanged. For example, while making details of a restored facial image natural and enriching the restored facial images with details, this ensures that a face identity, a facial posture, and other information are authentic and unchanged. In addition, in view of the problem of face synthesis features not fully leveraged, a feature encoding module implementing control based on style vectors is designed in this application. This can improve controllability, diversity, and robustness of facial prior features, thereby improving face restoration capabilities and generalization abilities of a face generator.

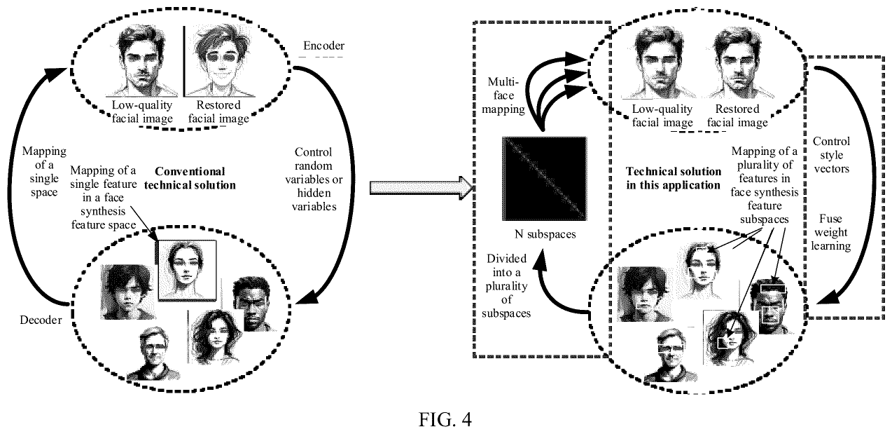

As shown in FIG. 4, core technologies of a technical solution provided in this application include at least the following: First, different from that the conventional technical solution is based on mapping of a single feature in a face synthesis feature space, a face restoration network framework provided in this application is based on mapping of a plurality of features in face synthesis feature subspaces. This ensures quality of face restoration that the face restoration solution based on a face generator can achieve in real and open scenarios. Second, different from that a feature encoding module in the conventional technical solution is configured to generate random variables or hidden variables, a feature encoding module in this application is configured to generate style vectors. This ensures that obtained features in synthesis spaces are more diverse, more effective, and more controllable.

With reference to specific implementations, the following describes in detail the technical solution provided in this application.

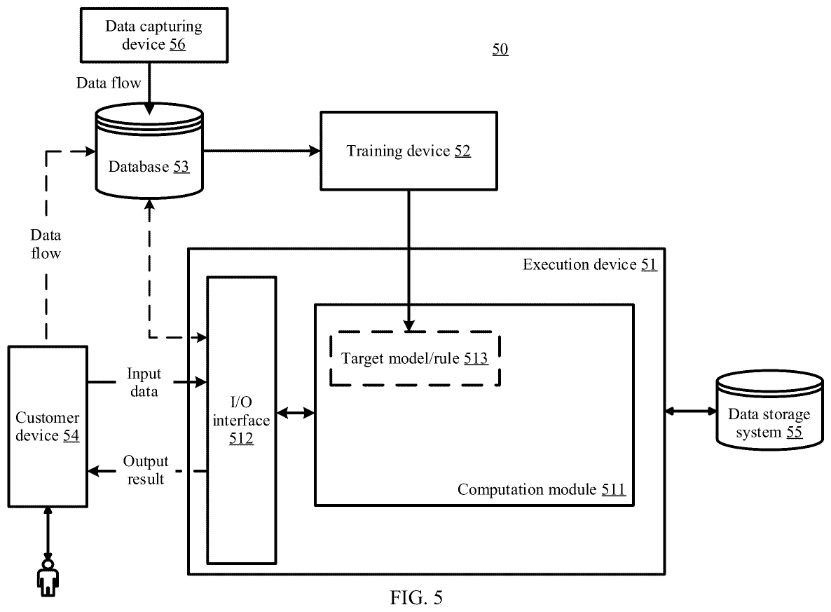

FIG. 5 shows a system architecture 50 according to an embodiment of this application. As shown in the system architecture 50, a data capturing device 56 is configured to capture training data and store the training data into a database 53. The training data in this embodiment of this application includes at least one of the following: a second random vector, a first facial feature, a first facial image, and a third random vector. A training device 52 performs training using the training data maintained in the database 53 to obtain a target model/rule 513. The following describes in more detail how the training device 52 obtains the target model/rule 513 based on the training data. The target model/rule 513 can be used to implement a facial image processing method provided in an embodiment of this application. To be specific, after a low-quality facial image and a first random vector are input into the target model/rule 513, a first synthetic facial image can be obtained. The target model/rule 513 in this embodiment of this application may be specifically a face restoration network. It should be noted that during actual application, the training data maintained in the database 53 is not necessarily all captured by the data capturing device 56, but may also be received from other devices. In addition, it should be noted that the training device 52 also does not necessarily train the target model/rule 513 based on only the training data maintained in the database 53, but may also obtain training data from a cloud or other places for model training. The foregoing description should not be used as a limitation on embodiments of this application.

The target model/rule 513 obtained through training performed by the training device 52 may be used in different systems or devices, for example, used in an execution device 51 shown in FIG. 5. The execution device 51 may be a terminal, for example, a mobile phone, a tablet computer, a notebook computer, an AR/VR terminal, or a vehicle-mounted terminal, or may be a server or cloud, or the like. In FIG. 5, the execution device 51 is configured with an I/O interface 512, which is configured for data exchange with an external device. A user may input data to the I/O interface 512 through a customer device 54. The input data may include a low-quality facial image, a first random vector, and other random vectors in this embodiment of this application.

When a computation module 511 in the execution device 51 performs computation or another related processing, the execution device 51 may invoke data, code, and the like in a data storage system 55 for use in the corresponding processing, and may also store data, instructions, and the like obtained through the corresponding processing into the data storage system 55.

Finally, the I/O interface 512 returns a processing result, for example, the obtained first synthetic facial image, to the customer device 54. In this way, the processing result is provided to the user.

It should be noted that for different objectives or different tasks, the training device 52 may generate corresponding target models/rules 513 based on different training data. The corresponding target models/rules 513 may be used to achieve the objectives or complete the tasks, providing users with desired results.

In a case shown in FIG. 5, a user may manually provide input data. The user may manually provide input data on a screen provided by the I/O interface 512. In another case, the customer device 54 may automatically send input data to the I/O interface 512. If the customer device 54 is required to obtain authorization from the user before automatically sending input data, the user may set corresponding permissions on the customer device 54. The user may check a result output by the execution device 51 on the customer device 54. Specific forms of presentation may be display, sounds, actions, and other specific forms. The customer device 54 may also serve as a data capturing end to capture, as new sample data, input data that is input into the I/O interface 512 and an output result that is output from the I/O interface 512, and store the input data and the output result into the database 53, where the input data and the output result are shown in the figure. Certainly, the input data that is input into the I/O interface 512 and the output result that is output from the I/O interface 512 may alternatively not be captured by the customer device 54, but are directly stored into the database 53 as new sample data by the I/O interface 512, where the input data and the output result are shown in the figure.

It should be noted that FIG. 5 is merely a schematic diagram of a system architecture according to an embodiment of this application. Positional relationships between the devices, components, modules, and the like shown in the figure do not constitute any limitation. For example, in FIG. 5, the data storage system 55 is an external memory for the execution device 51, but in another case, the data storage system 55 may be alternatively disposed in the execution device 51.

As shown in FIG. 5, the target model/rule 513 is obtained through training performed by the training device 52. The target model/rule 513 may be a face restoration network or the like in this embodiment of this application.

Optionally, in this application, the execution device 51 and the training device 52 may be a same electronic device.

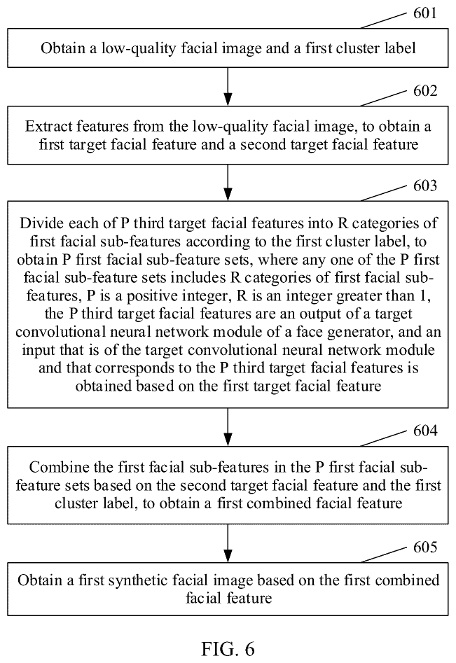

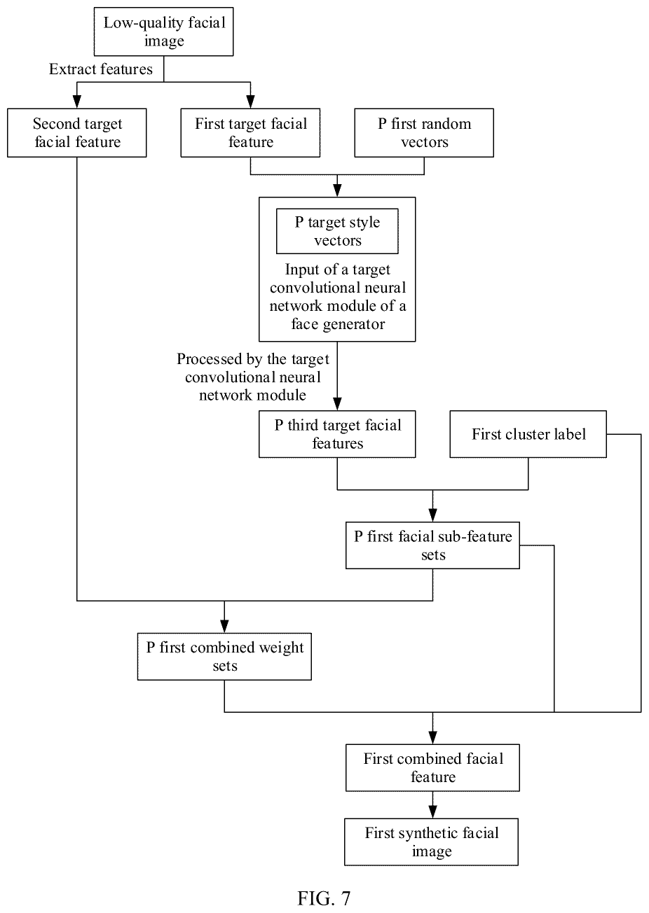

FIG. 6 shows a facial image processing method according to an embodiment of this application. The method may be performed by an electronic device. The method is described as a series of steps or operations. It should be understood that the method may be performed in various orders and/or the steps or operations may be performed simultaneously, and the method is not limited to an execution order shown in FIG. 6. In addition, the method shown in FIG. 6 may be understood with reference to FIG. 7. FIG. 7 is a schematic flowchart of facial image processing data according to an embodiment of this application. The method shown in FIG. 6 includes but is not limited to the following steps or operations.

601: Obtain a low-quality facial image and a first cluster label.

602: Extract features from the low-quality facial image, to obtain a first target facial feature and a second target facial feature.

Dimensions of the first target facial feature are different from dimensions of the second target facial feature. Optionally, the dimensions of the first target facial feature are less than the dimensions of the second target facial feature. Further, optionally, when features are extracted from the low-quality facial image, more than two facial features may be alternatively obtained, with the first target facial feature being the smallest of the obtained facial features in size.

It should be understood that the dimensions of the first target facial feature or the second target facial feature are a width and a height of the first target facial feature or the second target facial feature, expressed as width×height. In addition, dimensions of features or images described elsewhere in this application are all width×height.

603: Divide each of P third target facial features into R categories of first facial sub-features according to the first cluster label, to obtain P first facial sub-feature sets, where any one of the P first facial sub-feature sets includes R categories of first facial sub-features, P is a positive integer, R is an integer greater than 1, the P third target facial features are an output of a target convolutional neural network module of a face generator, and an input that is of the target convolutional neural network module and that corresponds to the P third target facial features is obtained based on the first target facial feature.

The P third target facial features correspond to the P first facial sub-feature sets. A first facial sub-feature set corresponding to any one of the P third target facial features includes R categories of first facial sub-features that are obtained through division of the any third target facial feature.

It should be noted that the target convolutional neural network module may also have a plurality of inputs, and the input of the target convolutional neural network module obtained based on the first target facial feature may be a part of all inputs of the target convolutional neural network module. The target convolutional neural network module processes all its inputs (including the input obtained based on the first target facial feature), to obtain the P third target facial features.

For a process of dividing each of the P third target facial features into the R categories of first facial sub-features according to the first cluster label, refer to FIG. 7.

604: Combine the first facial sub-features in the P first facial sub-feature sets based on the second target facial feature and the first cluster label, to obtain a first combined facial feature.

The dimensions of the second target facial feature may be the same as dimensions of the first facial sub-feature.

605: Obtain a first synthetic facial image based on the first combined facial feature.

The first synthetic facial image is a high-quality facial image restored based on the low-quality facial image, or the first synthetic facial image is a facial image enhanced based on the low-quality facial image.

It should be noted that the face generator is a multi-module or multi-layer structure. The target convolutional neural network module may be one of modules or layers of the face generator. The face generator further includes a subsequent structure connected to the target convolutional neural network module. In this application, the first combined facial feature may be input into the subsequent structure that is connected to the target convolutional neural network module and that is in the face generator. A final output of the face generator is the first synthetic facial image.

In this embodiment of this application, for a low-quality facial image, features are extracted from the facial image, to obtain a first target facial feature and a second target facial feature of the low-quality facial image. Based on the first target facial feature, an input of the target convolutional neural network module of the face generator is obtained. Based on the input, the target convolutional neural network module may output P third target facial features. Then, each of the P third target facial features is divided into R categories of first facial sub-features according to a first cluster label. In this way, P first facial sub-feature sets are obtained. Any first facial sub-feature set includes R categories of first facial sub-features. Then, based on the second target facial feature and the first cluster label, the first facial sub-features in the P first facial sub-feature sets are combined, to obtain a first combined facial feature. Finally, an enhanced first synthetic facial image can be obtained based on the first combined facial feature. For example, the first combined facial feature is input into a subsequent module that is connected to the target convolutional neural network module and that is in the face generator for processing, and an enhanced, high-quality first synthetic facial image is finally output. It should be understood that a third target facial feature constitutes a face synthesis feature space. After the third target facial feature is divided into R categories of first facial sub-features, each category of first facial sub-features of the R categories of first facial sub-features constitute a face synthesis feature subspace. Therefore, the R categories of first facial sub-features constitute R face synthesis feature subspaces, respectively. In addition, because there are P first facial sub-feature sets and each of the P first facial sub-feature sets includes R categories of first facial sub-features, each face synthesis feature subspace includes P first facial sub-features. To be specific, each face synthesis feature subspace includes a plurality of facial prior sub-features. Moreover, the first facial sub-features in the P first facial sub-feature sets are combined to obtain a first combined facial feature, that is, the plurality of facial prior sub-features in the face synthesis feature subspaces are fused to obtain a facial prior feature that is more effective. Therefore, a first synthetic facial image restored based on the first combined facial feature is an enhanced facial image. In this way, in this embodiment of this application, a face synthesis feature space is divided into subspaces, a plurality of facial prior sub-features in each face synthesis feature subspace are obtained, the plurality of facial prior sub-features in the face synthesis feature subspaces are then combined to obtain a facial prior feature that is more effective, and face restoration (or face enhancement) is then performed based on the facial prior feature that is obtained through combination, implementing leveraging of the facial prior feature during face restoration. This can not only improve quality of a facial image (for example, restoring naturalness of details), but also ensure that facial attributes (for example, a face identity, a facial posture, and other information) are authentic and unchanged.

In a possible implementation, the P third target facial features are obtained by performing convolutional modulation on the target convolutional neural network module based on the first target facial feature and P first random vectors.

As shown in FIG. 7, inputting an input of the target convolutional neural network module into the target convolutional neural network module for processing includes performing convolutional modulation on the target convolutional neural network module based on the input. For example, an input of the target convolutional neural network module is obtained based on the first target facial feature and the P first random vectors, and convolutional modulation is performed on the target convolutional neural network module based on the input. Then, the target convolutional neural network module outputs the P third target facial features.

The P third target facial features correspond to the P first random vectors.

The first random vector is an intermediate hidden variable w output by a network M of the face generator. For example, after a random vector z that follows a Gaussian distribution is input into the network M of the face generator, an output of the network M of the face generator is a first random vector.

In this implementation, convolutional modulation is performed on the target convolutional neural network module based on the first target facial feature and the P first random vectors, to obtain the P third target facial features. To be specific, the P third target facial features are an output that is obtained after convolutional modulation is performed on the target convolutional neural network module. By performing convolutional modulation on the target convolutional neural network module, a weight of a convolutional kernel in the target convolutional neural network module can be corrected. Therefore, when face restoration is performed based on the P third target facial features that are output after convolutional modulation is performed on the target convolutional neural network module, it can be ensured that facial attributes are authentic and unchanged during face restoration while quality of the facial image is improved.

In a possible implementation, the P third target facial features are obtained by performing convolutional modulation on the target convolutional neural network module based on P target style vectors, and the P target style vectors are obtained based on the first target facial feature and the P first random vectors.

The P third target facial features correspond to the P target style vectors, and the P target style vectors correspond to the P first random vectors.

As shown in FIG. 7, an input of the target convolutional neural network module includes a target style vector. The P target style vectors are obtained based on the first target facial feature and the P first random vectors. The P target style vectors are input into the target convolutional neural network module, so that convolutional modulation is performed on the target convolutional neural network module, to obtain the P third target facial features.

In this implementation, the face generator (or the target convolutional neural network module) implements control based on style vectors. For example, the P target style vectors are obtained based on the first target facial feature and the P first random vectors. Then, convolutional modulation is performed on the target convolutional neural network module based on the P target style vectors, to obtain the P third target facial features. Finally, face restoration is performed based on the P third target facial features. In this way, controllability, diversity, and robustness of the facial prior feature can be improved, and the facial prior feature is fully leveraged during face restoration, improving face restoration capabilities (for example, restoring more details of a facial image) and generalization abilities of the face generator.

In a possible implementation, the P target style vectors are obtained based on P first concatenated vectors, the P first concatenated vectors are obtained by concatenating a first feature vector to each of the P first random vectors, and the first feature vector is obtained based on the first target facial feature.

The P target style vectors correspond to the P first concatenated vectors, and the P first concatenated vectors correspond to the P first random vectors.

In this implementation, first, the first target facial feature is converted into the first feature vector. Then, the first feature vector is concatenated to each of the P first random vectors, to obtain the P first concatenated vectors. Then, the P target style vectors are obtained based on the P first concatenated vectors. For example, the P first concatenated vectors are input into a first fully connected layer, to obtain the P target style vectors. In this way, the P target style vectors can be obtained based on the first target facial feature and the P first random vectors, helping the face generator (or the target convolutional neural network module) implement control based on style vectors.

In a possible implementation, the combining the first facial sub-features in the P first facial sub-feature sets based on the second target facial feature and the first cluster label, to obtain a first combined facial feature includes: obtaining P first combined weight sets based on the second target facial feature and the P first facial sub-feature sets, where the P first combined weight sets correspond to the P first facial sub-feature sets, any one of the P first combined weight sets includes R first combined weights, the R first combined weights correspond to R categories of first facial sub-features in a first target facial sub-feature set, the first target facial sub-feature set is a first facial sub-feature set that corresponds to the any first combined weight set and that is of the P first facial sub-feature sets, and any one of the R first combined weights is obtained based on the second target facial feature and a first facial sub-feature that is in a category corresponding to the any first combined weight and that is in the first target facial sub-feature set; and combining the first facial sub-features in the P first facial sub-feature sets based on the first cluster label and the P first combined weight sets, to obtain the first combined facial feature.

The any first combined weight is obtained by performing convolution and pooling operations on a first concatenated feature. An output of a convolution operation is an input of a pooling operation. The first concatenated feature is obtained by concatenating the second target facial feature and the first facial sub-feature corresponding to the any first combined weight.

In this implementation, a first combined weight corresponding to each first facial sub-feature is obtained based on the second target facial feature and each first facial sub-feature. For example, the second target facial feature is concatenated to each first facial sub-feature, and then convolution and pooling operations are performed on a result that is obtained after the second target facial feature is concatenated to each first facial sub-feature, to obtain the first combined weight corresponding to each first facial sub-feature. Then, the first facial sub-features are combined based on the first cluster label and the first combined weight corresponding to each first facial sub-feature, to obtain the first combined facial feature. In this way, because the first combined weight corresponding to each first facial sub-feature is obtained based on the second target facial feature and the first facial sub-feature, it can be ensured that the first combined facial feature obtained through combination is a facial prior feature that is more effective.

In a possible implementation, the combining the first facial sub-features in the P first facial sub-feature sets based on the first cluster label and the P first combined weight sets, to obtain the first combined facial feature includes: obtaining P second facial sub-feature sets based on the P first facial sub-feature sets and the P first combined weight sets, where the P first facial sub-feature sets correspond to the P second facial sub-feature sets, any one of the P second facial sub-feature sets includes R categories of second facial sub-features, the R categories of second facial sub-features correspond to R categories of first facial sub-features in a second target facial sub-feature set, the second target facial sub-feature set is a first facial sub-feature set that corresponds to the any second facial sub-feature set and that is of the P first facial sub-feature sets, a second facial sub-feature in any category of the R categories of second facial sub-features is obtained by multiplying a first target facial sub-feature by a first target combined weight, the first target facial sub-feature is a first facial sub-feature that is in a category corresponding to the any category of second facial sub-features, and the first target combined weight is a first combined weight corresponding to the first target facial sub-feature; adding up second facial sub-features that are in a same category in the P second facial sub-feature sets, to obtain R third facial sub-features; multiplying the first cluster label by each of the R third facial sub-features, to obtain R fourth facial sub-features; and combining the R fourth facial sub-features, to obtain the first combined facial feature.

In this implementation, each first facial sub-feature in the P first facial sub-feature sets is multiplied by a first combined weight corresponding to the first facial sub-feature, to obtain a second facial sub-feature corresponding to each first facial sub-feature. Because there are R categories of first facial sub-features, there are R categories of second facial sub-features. Each of the R categories has P second facial sub-features. Of the R categories of second facial sub-features, second facial sub-features in a category are added up, to obtain the R third facial sub-features. The first cluster label is multiplied by each of the R third facial sub-features, to obtain the R fourth facial sub-features. The R fourth facial sub-features are combined, to obtain the first combined facial feature. In this way, the first facial sub-features in the P first facial sub-feature sets can be combined to obtain the first combined facial feature.

In a possible implementation, the first cluster label is obtained by performing one-hot encoding on a second cluster label, the second cluster label is obtained by processing a similarity matrix using a preset clustering method, the similarity matrix is obtained based on a first self-expressive matrix, the first self-expressive matrix is obtained by training a second self-expressive matrix based on a plurality of first facial features, the plurality of first facial features are obtained after a plurality of second random vectors are input into the face generator separately, and the plurality of first facial features are an output of the target convolutional neural network module.

The plurality of first facial features correspond to the plurality of second random vectors.

It should be noted that the first random vector and the second random vector are different random vectors. The first random vector is an intermediate hidden variable @ output by the network M of the face generator, that is, the first random vector is a random vector processed by the network M of the face generator. The second random vector is a random vector not processed by the network M of the face generator. For example, the second random vector is a random vector z that follows the Gaussian distribution.

In this implementation, the first cluster label is obtained by performing one-hot encoding on the second cluster label, the second cluster label is obtained by processing the similarity matrix using the preset clustering method, the similarity matrix is obtained based on the first self-expressive matrix, and the first self-expressive matrix is obtained through training. In this way, the first cluster label is obtained through training, facilitating division of the third target facial feature.

In a possible implementation, the first self-expressive matrix is obtained by performing the following operations, and for the plurality of first facial features, the following operations are performed, to obtain the first self-expressive matrix: S11: multiplying a fourth target facial feature by a first target self-expressive matrix, to obtain a fourth facial feature, where the fourth target facial feature is one of the plurality of first facial features; S12: obtaining a second synthetic facial image based on the fourth facial feature; S13: obtaining a first loss based on the fourth target facial feature and the second synthetic facial image; S14: if the first loss is less than a first preset threshold, using the first target self-expressive matrix as the first self-expressive matrix, or if the first loss is not less than a first preset threshold, adjusting an element in the first target self-expressive matrix based on the first loss to obtain a second target self-expressive matrix, and performing step S15; and S15: continuing to perform step S11 to step S14 with a fifth target facial feature as the fourth target facial feature and the second target self-expressive matrix as the first target self-expressive matrix, where the fifth target facial feature is a first facial feature that is not used for training yet and that is of the plurality of first facial features, and when step S11 is performed for the first time, the first target self-expressive matrix is the second self-expressive matrix.

In this implementation, the second self-expressive matrix is trained iteratively using the plurality of first facial features output by the face generator, that is, the second self-expressive matrix is optimized to obtain the first self-expressive matrix. This helps obtain an appropriate second cluster label and further obtain an appropriate first cluster label.

It should be noted that the facial image processing method shown in FIG. 6 can be implemented based on a face restoration network. The following describes an example of a face restoration network that is used to implement the facial image processing method shown in FIG. 6.

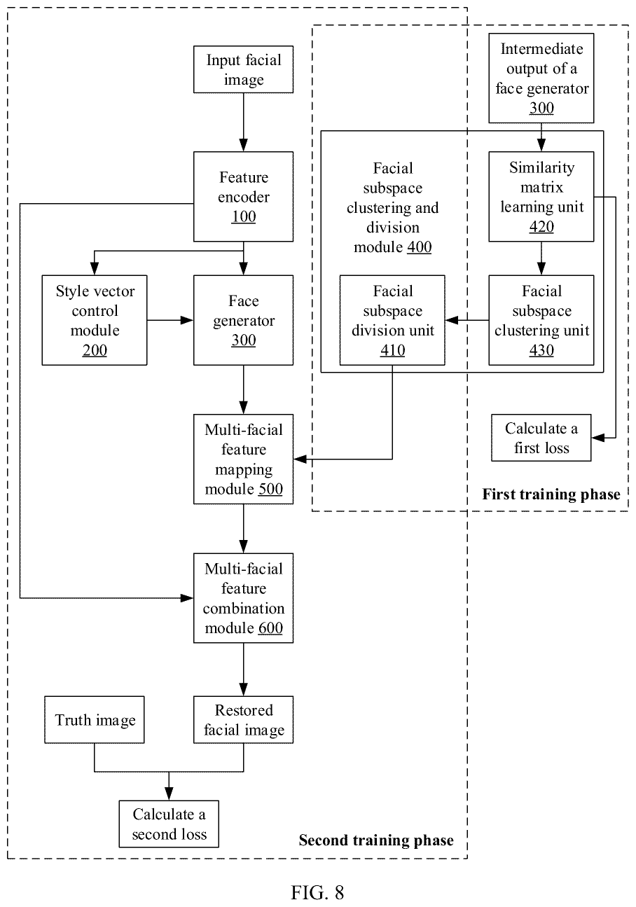

FIG. 8 is a schematic diagram of a structure of a face restoration network according to an embodiment of this application. The face restoration network includes a feature encoder 100, a style vector control module 200, a face generator 300, a facial subspace clustering and division module 400, a multi-facial feature mapping module 500, and a multi-facial feature combination module 600. The facial subspace clustering and division module 400 includes a facial subspace division unit 410, a similarity matrix learning unit 420, and a facial subspace clustering unit 430.

Training of the face restoration network is carried out in two phases. Details are as follows: The facial subspace clustering and division module 400 participates in a first training phase, and the feature encoder 100, the style vector control module 200, the face generator 300, the multi-facial feature mapping module 500, and the multi-facial feature combination module 600 participate in a second training phase; or the similarity matrix learning unit 420 and the facial subspace clustering unit 430 participate in a first training phase, and the facial subspace division unit 410, the feature encoder 100, the style vector control module 200, the face generator 300, the multi-facial feature mapping module 500, and the multi-facial feature combination module 600 participate in a second training phase. Details are described below.

### 1. First Training Phase

A training sample in the first training phase includes a plurality of first facial features output by the face generator 300. The plurality of first facial features are several intermediate results output by the face generator 300. The plurality of first facial features are obtained after a plurality of second random vectors are input into the face generator 300 separately. The plurality of first facial features are in a one-to-one correspondence with the plurality of second random vectors. For example, the plurality of second random vectors may be a plurality of random vectors z that follow a Gaussian distribution. In the first training phase, the facial subspace clustering and division module 400 is iteratively trained a plurality of times using the plurality of first facial features, to obtain a first cluster label. Alternatively, in the first training phase, the similarity matrix learning unit 420 and the facial subspace clustering unit 430 are iteratively trained a plurality of times using the plurality of first facial features, to obtain a second cluster label.

The face generator 300 may be a pre-trained face generator, including but not limited to a style-based generator network (stylegan) and a second-generation style-based generator network (stylegan2).

It should be noted that because the face generator 300 is a multi-layer network structure, the first facial features include output results of one or more intermediate layers in the face generator 300. In addition, whether the first facial features specifically include output results of one intermediate layer in the face generator 300 or include output results of a plurality of intermediate layers in the face generator 300 is determined based on an actual requirement. Moreover, an intermediate layer or intermediate layers in the face generator 300 whose output results are specifically included in the first facial features are also determined based on an actual requirement.

The following describes the first training phase using an example in which a plurality of first facial features are all output results of one intermediate layer in the face generator 300. Details are as follows.

Step 1: For the plurality of first facial features, perform the following operations, to obtain a first self-expressive matrix.

S11: Input a fourth target facial feature into the similarity matrix learning unit 420, to obtain a fourth facial feature, where the fourth target facial feature is one of the plurality of first facial features.

The similarity matrix learning unit 420 is configured to: receive a feature F_{g}^{i,k}, and multiply the feature F_{g}^{i,k} by a self-expressive matrix C, to obtain a feature \hat{F}_{g}ⁱ. The feature F_{g}^{i,k} represents an output feature of the face generator 300, where k∈{1, 2, . . . , P}, and i∈{1, 2, . . . , Q}. Matrix dimensions of the self-expressive matrix C are N_{g}×N_{g}. N_{g} is a clustering dimension of the feature F_{g}^{i,k}, for example, a channel dimension or a spatial dimension. The self-expressive matrix C is used to describe similarity between the features F_{g}^{i,k} in the channel dimension or spatial dimension.

It should be noted that if a plurality of features F_{g}^{i,k} are all output results of one intermediate layer in the face generator 300, there is only one self-expressive matrix C. The output results of the intermediate layer correspond to the self-expressive matrix C. In the first training phase, any one of the plurality of features Fa is multiplied by the self-expressive matrix C. If a plurality of features F_{g}^{i,k} are output results of a plurality of intermediate layers in the face generator 300, there are a plurality of self-expressive matrices C. The output results of the plurality of intermediate layers are in a one-to-one correspondence with the plurality of self-expressive matrices C. Any one of the plurality of features F_{g}^{i,k} is multiplied by a self-expressive matrix C corresponding to the feature.

For example, because the plurality of first facial features are all output results of one intermediate layer (for example, a target convolutional neural network module) in the face generator 300, the similarity matrix learning unit 420 is specifically configured to multiply the fourth target facial feature by a first target self-expressive matrix, to obtain the fourth facial feature. In this case, the feature F_{g}^{i,k} is the fourth target facial feature, the self-expressive matrix C is the first target self-expressive matrix, and the feature \hat{F}_{g}ⁱ is the fourth facial feature.

It should be understood that the similarity matrix learning unit 420 is trained in the first training phase to obtain the first self-expressive matrix, that is, constantly adjusting an element in the first target self-expressive matrix to obtain the first self-expressive matrix. When the similarity matrix learning unit 420 is trained for the first time, the first target self-expressive matrix is an initial self-expressive matrix. For example, the initial self-expressive matrix is a second self-expressive matrix.

S12: Input the fourth facial feature into the face generator 300, to obtain a second synthetic facial image.

The similarity matrix learning unit 420 is further configured to input the feature \hat{F}_{g}ⁱ into the face generator 300. The face generator 300 outputs a synthetic facial image.

For example, the feature \hat{F}_{g}ⁱ is the fourth facial feature. The similarity matrix learning unit 420 is further configured to input the fourth facial feature into the face generator 300, to obtain the second synthetic facial image. In this case, the feature \hat{F}_{g}ⁱ is the fourth facial feature. The synthetic facial image output by the face generator 300 is the second synthetic facial image.

S13: Obtain a first loss based on the fourth target facial feature and the second synthetic facial image.

The first loss is calculated based on the feature F_{g}^{i,k} and the synthetic facial image.

For example, the feature F_{g}^{i,k} is the fourth target facial feature, and the synthetic facial image is the second synthetic facial image. In this case, the first loss is obtained through calculation that is performed based on the fourth target facial feature and the second synthetic facial image.

S14: If the first loss is less than a first preset threshold, use the first target self-expressive matrix as the first self-expressive matrix; or if the first loss is not less than a first preset threshold, adjust an element in the first target self-expressive matrix based on the first loss to obtain a second target self-expressive matrix, and perform step S15.

The first loss is used to adjust an element in the self-expressive matrix C, to obtain an updated self-expressive matrix C.

For example, the self-expressive matrix C is the first target self-expressive matrix. In this case, the first loss is used to adjust an element in the first target self-expressive matrix, to obtain the second target self-expressive matrix. The second target self-expressive matrix is the updated self-expressive matrix C.

S15: Continue to perform step S11 to step S14 with a fifth target facial feature of the plurality of first facial features as the fourth target facial feature and the second target self-expressive matrix as the first target self-expressive matrix, where the fifth target facial feature is a first facial feature that is not input into the face generator 300 yet and that is of the plurality of first facial features.

Step 2: Input the first self-expressive matrix into the facial subspace clustering unit 430, to obtain a second cluster label.

The facial subspace clustering unit 430 is configured to: receive the self-expressive matrix C output by the similarity matrix learning unit 420, that is, using the self-expressive matrix C as an input; process the self-expressive matrix C, to obtain a similarity matrix A; and process the similarity matrix using a preset clustering method, to obtain the second cluster label.

A process of obtaining the similarity matrix A based on the self-expressive matrix C is as follows:

$$A = 1 / 2 ( \vert C \vert + {\vert C \vert}^{T} )$$

The preset clustering methods include but are not limited to a spectral clustering algorithm and a k-means clustering algorithm (k-means).

For example, the self-expressive matrix C is the first self-expressive matrix. In this case, the facial subspace clustering unit 430 is specifically configured to: obtain the similarity matrix A based on the first self-expressive matrix, and then process the similarity matrix A using a preset clustering method, to obtain the second cluster label.

Step 3: Input the second cluster label into the facial subspace division unit 410, to obtain a first cluster label.

The facial subspace division unit 410 is configured to: receive the second cluster label output by the facial subspace clustering unit 430, and perform one-hot encoding on the second cluster label. The first cluster label is obtained through one-hot encoding.

For example, a second cluster label of a feature channel is 5. After one-hot encoding is performed, an obtained first cluster label is [0, 0, 0, 0, 1].

It should be noted that step 3 is optional in the first training phase. If the entire facial subspace clustering and division module 400 participates in the first training phase, step 3 is performed in the first training phase. If the similarity matrix learning unit 420 and the facial subspace clustering unit 430 participate in the first training phase, step 3 is not performed in the first training phase.

### 2. Second Training Phase

If step 3 is not performed in the first training phase, a sample in the second training phase includes a plurality of first facial images, a plurality of random vector sets, and the second cluster label. Any one of the plurality of random vector sets includes P third random vectors, and P is a positive integer. Because the second training phase includes step 3, step 3 needs to be performed first, to convert the second cluster label into the first cluster label. If step 3 is performed in the first training phase, the sample in the second training phase includes the plurality of first facial images, the plurality of random vector sets, and the first cluster label. Optionally, the first facial images may be low-quality facial images.

For example, a structure of the face generator 300 may be shown in FIG. 1 to FIG. 3. To be specific, the face generator 300 includes two parts: a network M and a network G. An input of the network M is a one-dimensional vector (for example, a one-dimensional vector of a dimension 512). An output of the network M is also a one-dimensional vector (for example, a one-dimensional vector of a dimension 512). The third random vectors are obtained after random vectors that follow the Gaussian distribution are input into the network M of the face generator 300.

Besides step 3, the second training phase includes step 4. Details are as follows.

Step 4: For the plurality of first facial images, the plurality of random vector sets, and the first cluster label, perform the following operations to obtain the face restoration network.

S21: Input a second facial image into the feature encoder 100, to obtain M fifth facial features and a second feature vector. The second facial image is one of the plurality of first facial images. M is an integer greater than 1.

The feature encoder 100 is configured to: receive an input facial image Iᵢₙₚᵤₜ; extract features from the input facial image Iᵢₙₚᵤₜ, to obtain several features Fₑ^{j}, where j∈{1, 2, . . . , M}, the several features Fₑ^{j} differ from each other in dimensions, and a larger j indicates that Fₑ^{j} is of smaller dimensions; and obtain a control vector we based on a feature Fₑ^{M} of smallest dimensions of the several features Fₑ^{j}.

The feature encoder 100 may include M first feature extraction modules. An input of a (j+1)^{th} first feature extraction module of the M first feature extraction modules is an output of a j^{th} first feature extraction module of the M first feature extraction modules. An output of any one of the M first feature extraction modules is a feature Fₑ^{j}. Optionally, an input of a 1^{st} first feature extraction module of the M first feature extraction modules is the input facial image Iᵢₙₚᵤₜ, or a feature that is obtained after features are extracted from the input facial image Iᵢₙₚᵤₜ.

A process in which the feature encoder 100 obtains the control vector we based on the feature Fₑ^{M} may be as follows: The feature Fₑ^{M} is input into several second fully connected layers, to obtain the control vector ωₑ. It should be understood that the feature encoder 100 may or may not include the several second fully connected layers. For example, when the feature encoder 100 does not include the several second fully connected layers, the several second fully connected layers may be several networks M of the face generator 300. To be specific, the feature encoder 100 inputs the feature Fₑ^{M} into the several networks M, to obtain the control vector ωₑ.

It should be noted that the feature encoder 100 is a multi-layer network structure. The several features Fₑ^{j} are output results of several layers of a plurality of layers in the feature encoder 100, respectively.

For example, the input facial image Iᵢₙₚᵤₜ is the second facial image. The feature encoder 100 is specifically configured to: extract features from the second facial image, to obtain the M fifth facial features; and input a sixth target facial feature into the several second fully connected layers, to obtain the second feature vector. The M fifth facial features differ in dimensions. The sixth target facial feature is one of the M fifth facial features. Optionally, the sixth target facial feature is a fifth facial feature of smallest dimensions of the M fifth facial features. In this case, the several features Fₑ^{j} are the M fifth facial features, the feature Fₑ^{M} is the sixth target facial feature, and the control vector ωₑ is the second feature vector.

S22: Input P third random vectors in a first target random vector set and the second feature vector into the style vector control module 200, to obtain P second style vector sets. The first target random vector set is one of the plurality of random vector sets. The P third random vectors in the first target random vector set are in a one-to-one correspondence with the P second style vector sets. Any one of the P second style vector sets includes Q second style vectors, where Q is a positive integer.

The style vector control module 200 is configured to: receive the control vector ωₑ output by the feature encoder 100, and receive a random vector ωᵣ^{k}, where k∈{1, 2, . . . , P}; and concatenate the control vector ωₑ and the random vector ωᵣ^{k} in the channel dimension, and input a result that is obtained after the control vector ωₑ and the random vector ωᵣ^{k} are concatenated, into each of Q first fully connected layers, to obtain Q style vectors Sₑ^{i,k}, where k∈{1, 2, . . . , P}, and i∈{1, 2, . . . , Q}. The Q style vectors Sₑ^{i,k} are in a one-to-one correspondence with the Q first fully connected layers. Any one of the Q style vectors Sₑ^{i,k} is an output of a first fully connected layer corresponding to the style vector Sₑ^{i,k}. It should be understood that the style vector control module 200 includes the Q first fully connected layers.

The random vector ωᵣ^{k} is an intermediate hidden variable ω output by the network M of the face generator. To be specific, after a random vector z that follows the Gaussian distribution is input into the network M of the face generator, an output of the network M of the face generator is the random vector ωᵣ^{k}.

For example, the random vector ωᵣ^{k} is any one of the P third random vectors in the first target random vector set, and the control vector ωₑ is the second feature vector. The any third random vector is concatenated to the second feature vector, to obtain a second concatenated vector. The second concatenated vector is a result that is obtained after the any third random vector is concatenated to the second feature vector. The second concatenated vector is input into each of the Q first fully connected layers, to obtain Q second style vectors corresponding to the any third random vector. The Q second style vectors corresponding to the any third random vector constitute a second style vector set corresponding to the any third random vector. In this case, the Q style vectors Sₑ^{i,k} are the Q second style vectors corresponding to the any third random vector. Likewise, because the first target random vector set has P third random vectors, each of the P third random vectors is concatenated to the second feature vector, and second concatenated vectors that are obtained after each third random vector is concatenated to the second feature vector are input into each of the Q first fully connected layers, one second style vector set is obtained correspondingly for each third random vector. In this way, the P third random vectors correspond to P second style vector sets, and each of the P second style vector sets includes Q second style vectors.

S23: Input the P second style vector sets into the face generator 300 so that a convolutional modulation (Mod) operation is performed on the face generator 300, to obtain P second facial feature sets. The P second facial feature sets are in a one-to-one correspondence with the P second style vector sets. Any one of the P second facial feature sets includes Q sixth facial features. The Q sixth facial features are in a one-to-one correspondence with Q second style vectors in a second target style vector set. The second target style vector set is a second style vector set that corresponds to the any second facial feature set and that is of the P second style vector sets. Any one of the Q sixth facial features is obtained by performing convolutional modulation on the face generator 300 based on a second style vector corresponding to the any sixth facial feature.

The face generator 300 is configured to: receive a style vector Sₑ^{i,k}, perform convolutional modulation with the style vector Sₑ^{i,k} and a constant (Const) as inputs, and output a feature F_{g}^{i,k}, where k∈{1, 2, . . . , P}, and i∈{1, 2, . . . , Q}.

It should be noted that in a convolutional modulation process, the constant (Const) is a fixed input of the face generator 300. The face generator 300 includes Q convolutional neural network modules (for example, generative adversarial network modules). An input of a first convolutional neural network module of the Q convolutional neural network modules includes the constant (Const). An input of an i^{th} convolutional neural network module of the Q convolutional neural network modules includes an output of an (i−1)^{th} convolutional neural network module of the Q convolutional neural network modules. In addition, for any k, there are Q corresponding style vectors Sₑ^{i,k}. The Q style vectors Sₑ^{i,k} are in a one-to-one correspondence with the Q convolutional neural network modules. To be specific, each of the Q style vectors Sₑ^{i,k} is an input of a convolutional neural network module corresponding to the style vector Sₑ^{i,k}. In this case, the style vector Sₑ^{i,k} is an input of the i^{th} convolutional neural network module of the Q convolutional neural network modules. An output of the i^{th} convolutional neural network module of the Q convolutional neural network modules is the feature F_{g}^{i,k}.

By performing a convolutional modulation operation on the face generator 300, a weight of a convolutional kernel of each convolutional layer in the face generator 300 can be corrected. The convolutional modulation process may be expressed by the following formula:

w′_{abc}=Sₑ^{i,k}·w_{abc}

In the formula, Sₑ^{i,k} represents a style vector, w_{abc} represents a weight of a convolutional kernel corresponding to a case in which convolutional modulation is not performed, w′_{abc} represents a weight of the convolutional kernel corresponding to a case in which convolutional modulation is performed, a represents a number of a layer at which the convolutional kernel is located, and b and c represent spatial positions of the weight of the convolutional kernel. For example, b represents a row in which the weight of the convolutional kernel is located in the convolutional kernel, and c represents a column in which the weight of the convolutional kernel is located in the convolutional kernel.

For example, the style vector Sₑ^{i,k} is any second style vector in the P second style vector sets, and the feature F_{g}^{i,k} is a sixth facial feature corresponding to the any second style vector. In this case, after the any second style vector is input into the face generator 300, the sixth facial feature corresponding to the any second style vector is output. In addition, convolutional modulation is performed on the face generator 300 once, and a corrected face generator 300 is obtained.

It should be understood that the face generator 300 includes Q convolutional neural network modules, the input of the first convolutional neural network module of the Q convolutional neural network modules includes the constant (Const), and the input of the i^{th} convolutional neural network module of the Q convolutional neural network modules includes the output of the (i−1)^{th} convolutional neural network module of the Q convolutional neural network modules. In addition, any one of the P second style vector sets includes Q second style vectors. The Q second style vectors are in a one-to-one correspondence with the Q convolutional neural network modules. To be specific, each of the Q second style vectors is an input of a convolutional neural network module corresponding to the second style vector. Moreover, a second facial feature set that corresponds to the any second style vector set and that is of the P second facial feature sets includes Q sixth facial features. In this case, an i^{th} second style vector of the Q second style vectors is the input of the i^{th} convolutional neural network module of the Q convolutional neural network modules. The output of the i^{th} convolutional neural network module of the Q convolutional neural network modules is an i^{th} sixth facial feature of the Q sixth facial features. The target convolutional neural network module in the embodiment shown in FIG. 6 is any one of the Q convolutional neural network modules.

S24: Input each of P seventh target facial features into the multi-facial feature mapping module 500, to obtain P third facial sub-feature sets. The P seventh target facial features are P sixth facial features in the P second facial feature sets. The P seventh target facial features are sixth facial features in different second facial feature sets. The P seventh target facial features are obtained by performing convolutional modulation on the face generator 300 (specifically, the target convolutional neural network module) based on second style vectors output by a first fully connected layer. The P seventh target facial features are in a one-to-one correspondence with the P third facial sub-feature sets. Any one of the P third facial sub-feature sets includes R categories of fifth facial sub-features. The R categories of fifth facial sub-features included in the any third facial sub-feature set are obtained through division of a seventh target facial feature corresponding to the any third facial sub-feature set, where R is an integer greater than 1.

The multi-facial feature mapping module 500 is configured to: receive the feature F_{g}^{i,k} output by the face generator 300, and divide the feature F_{g}^{i,k} into R categories of sub-features F_{g,r}^{i,k} in the channel dimension or spatial dimension according to the first cluster label output by the facial subspace division unit 410, where k∈{1, 2, . . . , P}, i∈{1, 2, . . . , Q}, and r∈{1, 2, . . . , R}.

It should be noted that the first cluster label includes R categories. Therefore, the feature F_{g}^{i,k} is divided into R categories of sub-features F_{g,r}^{i,k}. In addition, the feature F_{g}^{i,k} corresponds to a feature space, and the sub-feature F_{g,r}^{i,k} corresponds to a subspace of the feature space.

For example, the feature F_{g}^{i,k} is any seventh target facial feature, and the sub-feature F_{g,r}^{i,k} is a fifth facial sub-feature. Therefore, according to the first cluster label, the any seventh target facial feature may be divided into R categories of fifth facial sub-features. The R categories of fifth facial sub-features obtained through division of the any seventh target facial feature constitute a third facial sub-feature set corresponding to the any seventh target facial feature. Likewise, because there are P seventh target facial features, and each of the P seventh target facial features is divided in the foregoing manner to obtain a third facial sub-feature set corresponding to each seventh target facial feature, P third facial sub-feature sets are obtained after the P seventh target facial features are divided. It should be understood that the P seventh target facial features are obtained by performing convolutional modulation on the face generator 300 based on second style vectors output by a first fully connected layer. To be specific, when the P seventh target facial features are expressed as the features F_{g}^{i,k}, values of i are the same, and k∈{1, 2, . . . , P}.

It should be further noted that when the features F_{g}^{i,k} are divided, because i∈{1, 2, . . . , Q}, features with a same value of i are selected from all the features F_{g}^{i,k} each time for feature division. For each value of i, because k∈{1, 2, . . . , P}, there are P features in total. After each of the P features is divided into R categories of sub-features, there are P groups of R categories of sub-features. The P groups of R categories of sub-features are also P sets each of which includes R categories of sub-features. i has Q values. When a value of i is selected from the Q values, which value of i is specifically selected may be determined based on an actual requirement. In addition, when a value of i is selected from the Q values, a quantity of selected values of i may also be determined based on an actual requirement. To be specific, features corresponding to one or more values of i are selected for feature division. In this application, only an example of selecting one value of i is described. It should be understood that a larger quantity of selected values of i indicates higher precision of the face restoration network. To be specific, a larger quantity of features that are divided indicates better face restoration capabilities of the face restoration network obtained through training, but also indicates an increase in an amount of computation. Therefore, an appropriate quantity of values of i may be selected, so that an excessive amount of computation is not added while quality of a facial image can be improved.

For example, each of the P second facial feature sets provides one sixth facial feature, and the sixth facial features constitute the P seventh target facial features. To be specific, in step S24, only an example of dividing some sixth facial features is described, with dividing all sixth facial features not described. In this application, a quantity of sixth facial features that are divided is not limited. The quantity of sixth facial features that are divided may be dynamically determined based on an actual requirement.

S25: Input an eighth target facial feature and the P third facial sub-feature sets into the multi-facial feature combination module 600, to obtain a second combined facial feature. The eighth target facial feature is one of the M fifth facial features, and the eighth target facial feature is not the sixth target facial feature. The sixth target facial feature is a feature of smallest dimensions of the M fifth facial features.

The multi-facial feature combination module 600 is configured to: receive the feature Fₑ^{j} output by the feature encoder 100 and the sub-feature F_{g,r}^{i,k} output by the multi-facial feature mapping module 500; obtain a combined weight wᵣ^{i,k} based on the feature Fₑ^{j} and the sub-feature F_{g,r}^{i,k}, where k∈{1, 2, . . . , P}, i∈{1, 2, . . . , Q}, and r∈{1, 2, . . . , R}; and calculate a weighted sum based on the sub-feature F_{g,r}^{i,k} and the combined weight wᵣ^{i,k}, to obtain a combined feature \tilde{F}_{g}ⁱ. Details are provided as follows.
(1) Obtain the combined weight wᵣ^{i,k}: The feature Fₑ^{j} is concatenated to the sub-feature F_{g,r}^{i,k} in the channel dimension or spatial dimension, and then several convolution and pooling operations are performed on a result that is obtained after the feature Fₑ^{j} is concatenated to the sub-feature F_{g,r}^{i,k}, to obtain the corresponding combined weight wᵣ^{i,k}.
(2) Obtain the combined feature \tilde{F}_{g}ⁱ.
a: The sub-feature F_{g,r}^{i,k} and the combined weight wᵣ^{i,k} are multiplied in a dimension of a superscript k, and results of the multiplication are added up.
b: A result of the addition in step a is multiplied by the first cluster label, and results of the multiplication are combined in a dimension of a subscript r, to obtain the combined feature \tilde{F}_{g}ⁱ.

For example, the feature Fₑ^{j} is the eighth target facial feature, the sub-feature F_{g,r}^{i,k} is any fifth facial sub-feature in the P third facial sub-feature sets, the combined weight wᵣ^{i,k} is a second combined weight, and the combined feature \tilde{F}_{g}ⁱ is the second combined facial feature. In this case, a process of performing combination based on the eighth target facial feature and the P third facial sub-feature sets to obtain the second combined facial feature is as follows.
(1) Obtain a second combined weight corresponding to each fifth facial sub-feature: First, the eighth target facial feature is concatenated to each fifth facial sub-feature in the P third facial sub-feature sets in the channel dimension or spatial dimension, to obtain a result of concatenating the eighth target facial feature to each fifth facial sub-feature, for example, referred to as a second concatenated feature. Then, several convolution and pooling operations are performed on the second concatenated feature, to obtain the second combined weight corresponding to each fifth facial sub-feature.

To be specific, any second combined weight is obtained by performing convolution and pooling operations on a second concatenated feature. An output of a convolution operation is an input of a pooling operation. The second concatenated feature is obtained by concatenating the eighth target facial feature and a fifth facial sub-feature corresponding to the any second combined weight.

Therefore, P second combined weight sets can be obtained based on the eighth target facial feature and the P third facial sub-feature sets. The P second combined weight sets correspond to the P third facial sub-feature sets. Any one of the P second combined weight sets includes R second combined weights. The R second combined weights correspond to R categories of fifth facial sub-features in a third target facial sub-feature set. The third target facial sub-feature set is a third facial sub-feature set that corresponds to the any second combined weight set and that is of the P third facial sub-feature sets. Any one of the R second combined weights is obtained based on the eighth target facial feature and a fifth facial sub-feature that is in a category corresponding to the any second combined weight and that is in the third target facial sub-feature set.
(2) Obtain the second combined facial feature.
a: First, each fifth facial sub-feature in the P third facial sub-feature sets is multiplied by the second combined weight corresponding to the fifth facial sub-feature, to obtain a sixth facial sub-feature corresponding to each fifth facial sub-feature. Because there are R categories of fifth facial sub-features, there are R categories of sixth facial sub-features. For the R categories of sixth facial sub-features, all sixth facial sub-features in a category are added up, to obtain a seventh facial sub-feature of the category. Because there are R categories, there are R seventh facial sub-features.
b: The first cluster label is multiplied by each of the R seventh facial sub-features, to obtain R eighth facial sub-features. Then, the R eighth facial sub-features are combined in the channel dimension or spatial dimension, to obtain the second combined facial feature.

Therefore, P fourth facial sub-feature sets can be obtained based on the P third facial sub-feature sets and the P second combined weight sets. The P third facial sub-feature sets correspond to the P fourth facial sub-feature sets. Any one of the P fourth facial sub-feature sets includes R categories of sixth facial sub-features. The R categories of sixth facial sub-features correspond to R categories of fifth facial sub-features in a fourth target facial sub-feature set. The fourth target facial sub-feature set is a third facial sub-feature set that corresponds to the any fourth facial sub-feature set and that is of the P third facial sub-feature sets. A sixth facial sub-feature in any category of the R categories of sixth facial sub-features is obtained by multiplying a second target facial sub-feature by a second target combined weight. The second target facial sub-feature is a fifth facial sub-feature that is in a category corresponding to the any category of sixth facial sub-features. The second target combined weight is a second combined weight corresponding to the second target facial sub-feature. Sixth facial sub-features that are in a same category in the P fourth facial sub-feature sets are added up, to obtain the R seventh facial sub-features. Then, the first cluster label is multiplied by each of the R seventh facial sub-features, to obtain the R eighth facial sub-features. Finally, the R eighth facial sub-features are combined, to obtain the second combined facial feature.

S26: Input the second combined facial feature into the face generator 300, to obtain a third synthetic facial image.

In step S26, the combined feature \tilde{F}_{g}ⁱ is input into the face generator 300, to obtain a restored facial image I_{rec}.

For example, the combined feature \tilde{F}_{g}ⁱ is the second combined facial feature, and the restored facial image I_{rec} is the third synthetic facial image. In this case, the second combined facial feature is input into the face generator 300, to obtain the third synthetic facial image.

S27: Calculate a second loss based on a truth image corresponding to the second facial image and the third synthetic facial image.

During training, each input facial image Iᵢₙₚᵤₜ corresponds to a truth image. The input facial image Iᵢₙₚᵤₜ is an input facial image. The truth image corresponding to the input facial image Iᵢₙₚᵤₜ is a high-quality version of the input facial image Iᵢₙₚᵤₜ. To be specific, the truth image corresponding to the input facial image Iᵢₙₚᵤₜ is the same as the input facial image Iᵢₙₚᵤₜ in screen content but different from the input facial image Iᵢₙₚᵤₜ in image quality. The restored facial image I_{rec} is an image that is obtained after the input facial image Iᵢₙₚᵤₜ is restored by the face restoration network. Therefore, image quality of the restored facial image I_{rec} can be determined based on the truth image corresponding to the input facial image Iᵢₙₚᵤₜ. Specifically, a loss in the second training phase (that is, the second loss) is calculated based on the truth image corresponding to the input facial image Iᵢₙₚᵤₜ and the restored facial image I_{rec}.

For example, any one of the plurality of first facial images corresponds to a truth image. Therefore, the second facial image also corresponds to a truth image. In this case, a second loss during this training can be calculated based on the truth image corresponding to the second facial image and the third synthetic facial image.

S28: If the second loss is less than a second preset threshold, end the training. The face restoration network in this case is a final face restoration network and can be used for inference. If the second loss is not less than a second preset threshold, adjust a parameter in the face restoration network based on the second loss to obtain an updated face restoration network, and perform step S29.

In the second training phase, modules whose parameters need to be updated based on the second loss include the feature encoder 100, the style vector control module 200, the face generator 300, the multi-facial feature combination module 600, and the like. It should be noted that with the parameters of the modules updated, parameters of the first fully connected layers and the second fully connected layers are also updated, the parameters of the face generator 300 are optionally updated, but none of parameters of the facial subspace division unit 410 and the multi-facial feature mapping module 500 is updated.

S29: Continue to perform step S21 to step S28 with a third facial image as the second facial image and a second target random vector set as the first target random vector set, to train the updated face restoration network. The third facial image is a first facial image that is not used for training yet and that is of the plurality of first facial images. The second target random vector set is a random vector set that is not used for training yet and that is of the plurality of random vector sets.

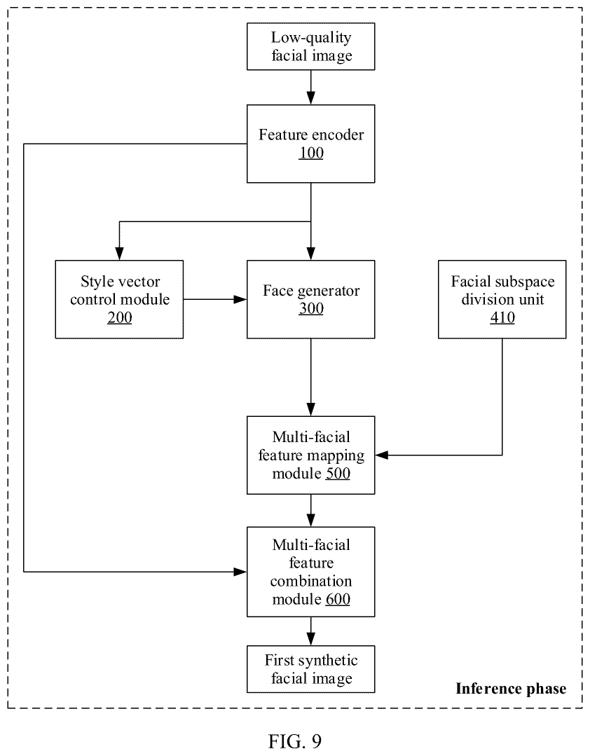

FIG. 9 is a schematic diagram of an inference phase of the face restoration network shown in FIG. 8. The inference phase of the face restoration network is described as follows.

The facial subspace division unit 410 is configured to output a first cluster label to the multi-facial feature mapping module 500.

The feature encoder 100 is configured to: receive an input facial image Iᵢₙₚᵤₜ; extract features from the input facial image Iᵢₙₚᵤₜ, to obtain several features Fₑ^{j}, where j∈{1, 2, . . . , M}, the several features Fₑ^{j} differ from each other in dimensions, and a larger j indicates that Fₑ^{j} is of smaller dimensions; and obtain a control vector ωₑ based on a feature Fₑ^{M} of smallest dimensions of the several features Fₑ^{j}.

For example, the input facial image Iᵢₙₚᵤₜ received by the feature encoder 100 is a low-quality facial image. The feature encoder 100 extracts features from the low-quality facial image. The obtained M features Fₑ^{j} are M second facial features. The M second facial features differ in dimensions. The M second facial features include a first target facial feature and a second target facial feature. Optionally, a feature Fₑ^{M} of smallest dimensions of the M second facial features is the first target facial feature. The control vector ωₑ obtained by the feature encoder 100 based on the first target facial feature is a first feature vector.

The style vector control module 200 is configured to: receive the control vector ωₑ output by the feature encoder 100, and receive a random vector ωᵣ^{k}, where k∈{1, 2, . . . , P}; and concatenate the control vector ωₑ and the random vector of in a channel dimension, and input a result that is obtained after the control vector ωₑ and the random vector of are concatenated, into each of the Q first fully connected layers, to obtain Q style vectors Sₑ^{i,k}, where i∈{1, 2, . . . , Q}. The Q style vectors stare in a one-to-one correspondence with the Q first fully connected layers. Any one of the Q style vectors Sₑ^{i,k} is an output of a first fully connected layer corresponding to the style vector Sₑ^{i,k}.

The random vector ωᵣ^{k} is an intermediate hidden variable ω output by the network M of the face generator. To be specific, after a random vector z that follows a Gaussian distribution is input into the network M of the face generator, an output of the network M of the face generator is the random vector ωᵣ^{k}.

For example, the control vector ωₑ received by the style vector control module 200 is the first feature vector, and the random vectors ωᵣ^{k} received by the style vector control module 200 are P first random vectors. The style vector control module 200 concatenates the first feature vector to any one of the P first random vectors. A result obtained from the concatenation is a first concatenated vector. Then, the style vector control module 200 inputs the first concatenated vector into each of the Q first fully connected layers. The obtained Q style vectors Sₑ^{i,k} are Q first style vectors. The Q first style vectors correspond to the Q first fully connected layers. Any one of the Q first style vectors is an output of a first fully connected layer corresponding to the first style vector.

It should be understood that because there are P first random vectors, the style vector control module 200 concatenates the first feature vector to each of the P first random vectors, to obtain P first concatenated vectors, and then inputs each of the P first concatenated vectors into each of the Q first fully connected layers, to obtain Q first style vectors corresponding to each first concatenated vector. Therefore, after the style vector control module 200 processes the first feature vector and the P first random vectors, P first style vector sets can be obtained. Any one of the P first style vector sets includes Q first style vectors.

The P first style vector sets include P target style vectors. To be specific, the P target style vectors are P first style vectors in the P first style vector sets. The P target style vectors are first style vectors in different first style vector sets of the P first style vector sets, respectively. The P target style vectors are obtained after the P first concatenated vectors are input into a same first fully connected layer of the Q first fully connected layers.

The face generator 300 is configured to: receive a style vector Sₑ^{i,k}, perform convolutional modulation with the style vector Sₑ^{i,k} and a constant (Const) as inputs, and output a feature F_{g}^{i,k}, where i∈{1, 2, . . . , Q}.

For example, the style vector Sₑ^{i,k} received by the face generator 300 is any first style vector in the P first style vector sets. With the any first style vector in the P first style vector sets and the constant (Const) as inputs, the feature F_{g}^{i,k} output by the face generator 300 is a third facial feature corresponding to the any first style vector.

It should be understood that because each first style vector set has Q first style vectors, Q third facial features can be obtained after the Q first style vectors are input into the face generator 300 for convolutional modulation. The Q third facial features constitute a first facial feature set corresponding to the first style vector set. Further, because there are P first style vector sets, P first facial feature sets can be obtained by performing convolutional modulation on the face generator 300 using the P first style vector sets. The P first facial feature sets are in a one-to-one correspondence with the P first style vector sets. Any one of the P first facial feature sets includes Q third facial features.

The multi-facial feature mapping module 500 is configured to: receive the feature F_{g}^{i,k} output by the face generator 300, and divide the feature F_{g}^{i,k} into R categories of sub-features F_{g,r}^{i,k} in the channel dimension or a spatial dimension according to the first cluster label output by the facial subspace division unit 410, where r∈{1, 2, . . . , R}.

For example, the features F_{g}^{i,k} received by the multi-facial feature mapping module 500 include P third target facial features. The P third target facial features are P third facial features in the P first facial feature sets. The P third target facial features are third facial features in different first facial feature sets. The P third target facial features are obtained by performing convolutional modulation on the face generator 300 (specifically, the target convolutional neural network module) based on first style vectors output by a first fully connected layer. Sub-features F_{g,r}^{i,k} that are obtained after the multi-facial feature mapping module 500 divides any one of the P third target facial features in the channel dimension or spatial dimension according to the first cluster label are first facial sub-features. To be specific, the any third target facial feature is divided into R categories of first facial sub-features. Each of the R categories includes a first facial sub-feature. Therefore, the R categories of first facial sub-features are also R first facial sub-features. The R categories of first facial sub-features obtained through division of the any third target facial feature constitute a first facial sub-feature set corresponding to the any third target facial feature.

It should be understood that because there are P third target facial features, P first facial sub-feature sets can be obtained after the multi-facial feature mapping module 500 processes the P third target facial features. In addition, any one of the P first facial sub-feature sets includes R categories of first facial sub-features.

The multi-facial feature combination module 600 is configured to: receive the feature Fₑ^{j} output by the feature encoder 100 and the sub-feature F_{g,r}^{i,k} output by the multi-facial feature mapping module 500; obtain a combined weight wᵣ^{i,k} based on the feature Fₑ^{j} and the sub-feature F_{g,r}^{i,k}; and calculate a weighted sum based on the sub-feature F_{g,r}^{i,k} and the combined weight wᵣ^{i,k}, to obtain a combined feature \tilde{F}_{g}ⁱ. Details are provided as follows.
(1) Obtain the combined weight wᵣ^{i,k}: The feature Fₑ^{j} is concatenated to the sub-feature F_{g,r}^{i,k} in the channel dimension or spatial dimension, and then several convolution and pooling operations are performed on a result that is obtained after the feature Fₑ^{j} is concatenated to the sub-feature F_{g,r}^{i,k}, to obtain the corresponding combined weight wᵣ^{i,k}.
(2) Obtain the combined feature \tilde{F}_{g}ⁱ.
a: The sub-feature F_{g,r}^{i,k} and the combined weight wᵣ^{i,k} are multiplied in a dimension of a superscript k, and results of the multiplication are added up.
b: A result of the addition in step a is multiplied by the first cluster label, and results of the multiplication are combined in a dimension of a subscript r, to obtain the combined feature \tilde{F}_{g}ⁱ.

For example, the feature Fₑ^{j} received by the multi-facial feature combination module 600 is the second target facial feature, and the sub-features F_{g,r}^{i,k} received by the multi-facial feature combination module 600 are first facial sub-features in any category in any one of the P first facial sub-feature sets.
(1) Obtain a first combined weight: First, the second target facial feature is concatenated to each of the first facial sub-features in the any category in the channel dimension or spatial dimension. Then, several convolution and pooling operations are performed on results that are obtained after the second target facial feature is concatenated to each of the first facial sub-features in the any category. An obtained combined weight wᵣ^{i,k} is the first combined weight corresponding to the first facial sub-features in the any category.

It should be understood that because a first facial sub-feature set includes R categories of first facial sub-features, R first combined weights can be obtained for the R categories of first facial sub-features. The R first combined weights constitute a first combined weight set corresponding to the first facial sub-feature set. Further, because there are P first facial sub-feature sets, there are P first combined weight sets. In addition, any one of the P first combined weight sets includes R first combined weights.
(2) Obtain a first combined facial feature.
a: First, each first facial sub-feature in the P first facial sub-feature sets is multiplied by the first combined weight corresponding to the first facial sub-feature, to obtain a second facial sub-feature corresponding to each first facial sub-feature. Because there are R categories of first facial sub-features, there are R categories of second facial sub-features. For the R categories of second facial sub-features, all second facial sub-features in a category are added up, to obtain a third facial sub-feature of the category. Because there are R categories, there are R third facial sub-features.
b: The first cluster label is multiplied by each of the R third facial sub-features, to obtain R fourth facial sub-features. Then, the R fourth facial sub-features are combined in the channel dimension or spatial dimension, to obtain the first combined facial feature.

The face generator 300 is further configured to: receive the combined feature \tilde{F}_{g}ⁱ, and with the combined feature \tilde{F}_{g}ⁱ as an input, obtain a restored facial image I_{rec}.

For example, the combined feature \tilde{F}_{g}ⁱ received by the face generator 300 is the first combined facial feature, and the restored facial image I_{rec} obtained by the face generator 300 for the first combined facial feature is a first synthetic facial image.

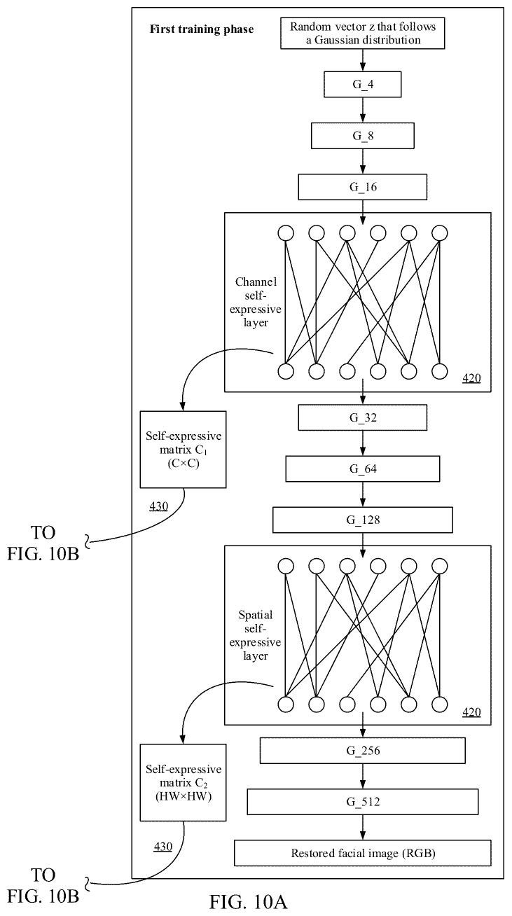

FIG. 10A and FIG. 10B are schematic diagrams of an example structure of the face restoration network shown in FIG. 8. The following describes a first training phase and a second training phase of a face restoration network shown in FIG. 10A and FIG. 10B.

### 1. First Training Phase

It should be noted in advance that a face generator 300 may use a stylegan2 network. The face generator 300 includes 23 convolutional neural network modules. FIG. 10A and FIG. 10B show only some of the 23 convolutional neural network modules: a convolutional neural network module G_4 (output features are of dimensions 4×4), a convolutional neural network module G_8 (output features are of dimensions 8×8), a convolutional neural network module G_16 (output features are of dimensions 16×16), a convolutional neural network module G_32 (output features are of dimensions 32×32), a convolutional neural network module G_64 (output features are of dimensions 64×64), a convolutional neural network module G_128 (output features are of dimensions 128×128), a convolutional neural network module G_256 (output features are of dimensions 256×256), and a convolutional neural network module G_512 (output features are of dimensions 512×512). Therefore, connection relationships between the convolutional neural network module G_4, the convolutional neural network module G_8, the convolutional neural network module G_16, the convolutional neural network module G_32, the convolutional neural network module G_64, the convolutional neural network module G_128, the convolutional neural network module G_256, and the convolutional neural network module G_512 shown in FIG. 10A and FIG. 10B do not necessarily indicate direct connections, or may indicate interface connections. For example, there may also be one or more convolutional neural network modules between two connected convolutional neural network modules shown in FIG. 10A and FIG. 10B.

For example, the target convolutional neural network module in the embodiment shown in FIG. 6 may be the convolutional neural network module G_16 or the convolutional neural network module G_128 shown in FIG. 10A and FIG. 10B.

For example, in FIG. 10A and FIG. 10B, the convolutional neural network module G_16 is a fifth convolutional neural network module of the 23 convolutional neural network modules, and the convolutional neural network module G_128 is an eleventh convolutional neural network module of the 23 convolutional neural network modules.

Step 1: Optimize a self-expressive matrix C₁ and a self-expressive matrix C₂, to obtain a final self-expressive matrix C₁ and a final self-expressive matrix C₂.

In the first training phase, a random vector z (for example, a second random vector) that follows a Gaussian distribution is input into the face generator 300. A feature output by the convolutional neural network module G_16 of the face generator 300 is extracted. The self-expressive matrix C₁ (of dimensions 512×512) is trained using the feature output by the convolutional neural network module G_16, to obtain the final self-expressive matrix C₁. In addition, a feature output by the convolutional neural network module G_128 of the face generator 300 is extracted. The self-expressive matrix C₂ (of dimensions 16384×16384) is trained using the feature output by the convolutional neural network module G_128, to obtain the final self-expressive matrix C₂. A process of obtaining the final self-expressive matrix C₁ and the final self-expressive matrix C₂ through training is specifically described as follows.
(1) The random vector z that follows the Gaussian distribution is input into the convolutional neural network module G_4 of the face generator 300, and processed by the convolutional neural network module G_4, the convolutional neural network module G_8, and the convolutional neural network module G_16 sequentially. In this case, a similarity matrix learning unit 420 is a channel self-expressive layer and is specifically configured to: extract a feature (denoted as a feature F_{g}⁵, of dimensions 16×16×512) output by the convolutional neural network module G_16, and multiply the feature F_{g}⁵ by the self-expressive matrix C₁, to obtain a feature \hat{F}_{g}⁵. The dimensions of the feature indicate width×height×quantity of channels.
(2) The feature \hat{F}_{g}⁵ is input into the convolutional neural network module G_32 of the face generator 300, and processed by the convolutional neural network module G_32, the convolutional neural network module G_64, and the convolutional neural network module G_128 sequentially. In this case, the similarity matrix learning unit 420 is a spatial self-expressive layer and is specifically configured to: receive a feature (denoted as a feature F_{g}¹¹ of dimensions 128×128×64) output by the convolutional neural network module G_128, and multiply the feature F_{g}¹¹ by the self-expressive matrix C₂, to obtain a feature \hat{F}_{g}¹¹.
(3) The feature \hat{F}_{g}¹¹ is input into a subsequent structure of the face generator 300, for example, the convolutional neural network module G_256. After the feature \hat{F}_{g}¹¹ is processed by the convolutional neural network module G_256 and the convolutional neural network module G_512, a synthetic facial image is obtained.

The self-expressive matrix C₁ is first optimized based on a loss function that is for the first training phase. Then, the self-expressive matrix C₁ is fixed. Next, the self-expressive matrix C₂ is optimized. In this way, the final optimized self-expressive matrix C₁ and self-expressive matrix C₂ are obtained. The loss function that is for the first training phase is as follows:

$$loss 1 = {‖ {G}_{1} ( z ) - {G}_{1} ( z ) {C}_{i} ‖}_{2} + {λ}_{1} {‖ {G}_{2} ( {G}_{1} ( z ) ) - {G}_{2} ( {G}_{1} ( z ) {C}_{i} ) ‖}_{1} + {λ}_{2} {‖ {C}_{i} ‖}_{1} , \\ i = 1 , 2$$

In the formula, loss1 represents a first loss; a face generator is divided into two parts: G₁ and G₂; z represents a random vector that follows a Gaussian distribution, for example, a second random vector; G₁(z) represents an intermediate feature that is obtained with the random vector z following the Gaussian distribution as an input; G₂ (G₁(z)) represents a facial image that is obtained with the random vector z following the Gaussian distribution as an input; G₂ (G₁(z)Cᵢ) represents a facial image that is obtained after matrix multiplication by the self-expressive matrix Cᵢ is performed; and λ₁ and λ₂ represent weights of loss components.

Step 2: Input the final self-expressive matrix C₁ into a facial subspace clustering unit 430, to obtain a second cluster label_1, and input the final self-expressive matrix C₂ into the facial subspace clustering unit 430, to obtain a second cluster label_2.

The facial subspace clustering unit 430 is configured to: obtain a similarity matrix A₁ with the final self-expressive matrix C₁ as an input, and process the similarity matrix A₁ using a preset clustering method (for example, a spectral clustering method), to obtain the second cluster label_1. In addition, the facial subspace clustering unit 430 is further configured to: obtain a similarity matrix A₂ with the final self-expressive matrix C₂ as an input, and process the similarity matrix A₂ using a preset clustering method (for example, a spectral clustering method), to obtain the second cluster label_2.

Step 3: Obtain a first cluster label_1 based on the second cluster label_1, and obtain a first cluster label_2 based on the second cluster label_2.

A facial subspace division unit 410 is configured to: perform one-hot encoding on the second cluster label_1, to obtain the first cluster label_1, where the first cluster label_1 includes m¹, m², m³, . . . , and m^{R}, as shown in FIG. 10B; and perform one-hot encoding on the second cluster label_2, to obtain the first cluster label_2, where the first cluster label_2 is not shown in FIG. 10B.

It should be noted that the first cluster label_1 is used for dividing a feature into R categories of sub-features in a channel dimension, and the first cluster label_2 is used for dividing a feature into R categories of sub-features in a spatial dimension.

### 2. Second Training Phase

Step 4: Input a low-quality facial image Iᵢₙₚᵤₜ into a feature encoder 100, to obtain a feature Fₑ³ (of dimensions 128×128×64), a feature Fₑ⁶ (of dimensions 16×16×512), a feature Fₑ⁷ (of dimensions 4×4×512), and a control vector ωₑ (of dimensions 512×1).

As shown in FIG. 10B, the feature encoder 100 includes seven first feature extraction modules and one second feature extraction module (not all the feature extraction modules are shown in FIG. 10B). Any one of the seven first feature extraction modules includes convolutional layers (Conv), activation layers (ReLU), and downsampling layers that are concatenated. Each of the seven first feature extraction modules uses a different downsampling multiple. The second feature extraction module includes convolutional layers (Conv) and activation layers (ReLU) that are concatenated. An input of the second feature extraction module is the input facial image Iᵢₙₚᵤₜ. An output of the second feature extraction module is an input of a 1^{st} first feature extraction module of the seven first feature extraction modules.

An input of a j^{th} first feature extraction module of the seven first feature extraction modules is an output of a (j−1)^{th} first feature extraction module of the seven first feature extraction modules. An output of a seventh first feature extraction module of the seven first feature extraction modules is inputs of two second fully connected layers. An output of the two second fully connected layers is the control vector ωₑ.

The feature encoder 100 is configured to: receive the input facial image Iᵢₙₚᵤₜ (of dimensions 512×512×3); extract features from the input facial image using one second feature extraction module and seven first feature extraction modules, to obtain the feature Fₑ³ (of dimensions 128×128×64) output by a third first feature extraction module of the seven first feature extraction modules, the feature Fₑ⁶ (of dimensions 16×16×512) output by a sixth first feature extraction module of the seven first feature extraction modules, and the feature Fₑ⁷ (of dimensions 4×4×512) output by the seventh first feature extraction module of the seven first feature extraction modules; and input the feature Fₑ⁷ into the two second fully connected layers, to obtain the control vector ωₑ (of dimensions 512×1).

Step 5: Input the control vector ωₑ (of dimensions 512×1) and random vectors ωᵣ^{k} (of dimensions 512×1) into a style vector control module 200, to obtain style vectors Sₑ^{i,k} (of dimensions 512×1), where k∈{1, 2, . . . , 10}, and i∈{1, 2, . . . , 23}.

The style vector control module 200 is configured to: receive the control vector ωₑ and the random vectors of (of dimensions 512×1), where k∈{1, 2, . . . , P}; and concatenate the control vector ωₑ to each random vector ωᵣ^{k} in the channel dimension, and input a result that is obtained after the control vector ωₑ is concatenated to each random vector wᵣ^{k} into each of Q first fully connected layers (not shown in FIG. 10B), to obtain Q style vectors Sₑ^{i,k} (of dimensions 512×1) corresponding to each random vector ωᵣ^{k}, where k∈{1, 2, . . . , P}, and i∈{1, 2, . . . , Q}.

For example, P=10, and Q=23. In this case, there are 10 random vectors ωᵣ^{k} and 23 first fully connected layers. The result that is obtained after the control vector ωₑ is concatenated to each random vector ωᵣ^{k} is input into each of the 23 first fully connected layers (not shown in FIG. 10B), to obtain 23 style vectors Sₑ^{i,k} (of dimensions 512×1) corresponding to each random vector ωᵣ^{k}, where k∈{1, 2, . . . , 10}, and i∈{1, 2, . . . , 23}.

Step 6: Input the style vectors Sₑ^{5,k} into the face generator 300 so that convolutional modulation operations are performed on the convolutional neural network module G_16 of the face generator 300, to obtain features F_{g}^{5,k} output by the convolutional neural network module G_16, where k∈{1, 2, . . . , 10}.

The face generator 300 is configured to: with the style vectors Sₑ^{i,k} as inputs of convolutional modulation operations of the face generator 300, output features F_{g}^{i,k}, where k∈{1, 2, . . . , P}, and i∈{1, 2, . . . , Q}.

For example, Q=23. In this case, the face generator includes 23 convolutional neural network modules. FIG. 10B shows only some of the 23 convolutional neural network modules. The convolutional neural network module G_16 is a fifth convolutional neural network module of the 23 convolutional neural network modules. Therefore, inputs for performing convolutional modulation on the convolutional neural network module G_16 include an output of a fourth convolutional neural network module of the 23 convolutional neural network modules and the style vectors Sₑ^{5,k}, where k∈{1, 2, . . . , 10}. An output of the convolutional neural network module G_16 is the features F_{g}^{5,k}, where k∈{1, 2, . . . , 10}. It should be noted that processes of performing convolutional modulation operations on other convolutional neural network modules of the 23 convolutional neural network modules are the same as the process of performing convolutional modulation operations on the convolutional neural network module G_16. Therefore, details are not described herein again.

Step 7: Input the features F_{g}^{5,k} into a multi-facial feature mapping module 500, to obtain sub-features F_{g,r}^{5,k}, where k∈{1, 2, . . . , 10}, and r∈{1, 2, . . . , 5}.

The multi-facial feature mapping module 500 is configured to: receive the features F_{g,r}^{i,k} output by the face generator 300, where k∈{1, 2, . . . , P}, and i∈{1, 2, . . . , Q}; and divide the features F_{g}^{i,k} into R categories of sub-features F_{g,r}^{i,k} in the channel dimension or spatial dimension according to the first cluster label output by the facial subspace division unit 410, where k∈{1, 2, . . . , P}, i∈{1, 2, . . . , Q}, and r∈{1, 2, . . . , R}. Specifically, for features output by any convolutional neural network module, values of i are the same. One of the features F_{g}^{i,k} (with values of i being the same) corresponds to one face mapping. Because k∈{1, 2, . . . , P}, there are P features F_{g}^{i,k}. The P features F_{g}^{i,k} correspond to P face mappings. Each of the P features F_{g}^{i,k} is divided into R categories of sub-features F_{g,r}^{i,k} according to the first cluster label, where k∈{1, 2, . . . , P}, i∈{1, 2, . . . , Q}, and r∈{1, 2, . . . , R}.

As shown in FIG. 10B, the features F_{g}^{5,k} output by the convolutional neural network module G_16 are divided into R categories of sub-features F_{g,r}^{5,k} in the channel dimension according to the first cluster label_1, where k∈{1, 2, . . . , P}, and r∈{1, 2, . . . , R}. For example, P=10, and R=5. In this case, there are 10 features F_{g}^{5,k}. The first cluster label_1 includes m¹, m², m³, . . . , and m⁵ Each of the 10 features F_{g}^{5,k} is divided into five categories of sub-features F_{g,r}^{5,k} according to the first cluster label_1, where k∈{1, 2, . . . , 10}, and r∈{1, 2, . . . , 5}.

Step 8: Input the feature Fₑ⁶ and the sub-features F_{g,r}^{5,k} into a multi-facial feature combination module 600, to obtain a combined feature \tilde{F}_{g}⁵, where k∈{1, 2, . . . , 10}, and r∈{1, 2, . . . , 5}. It should be understood that the feature Fₑ⁶ and the sub-features F_{g,r}^{5,k} are of same dimensions.

As shown in FIG. 10B, for any sub-feature F_{g,r}^{i,k}, because k∈{1, 2, . . . , P}, there are P subspaces correspondingly. In addition, because r∈{1, 2, . . . , R}, for any one of P values of k, R combined weights can be obtained based on the sub-features F_{g,r}^{5,k}. For example, for the sub-features F_{g,r}^{5,k}, k∈{1, 2, . . . , 10}, and r∈{1, 2, . . . , 5}. In this case, the sub-features F_{g,r}^{5,k} correspond to 10 subspaces, and each subspace corresponds to five combined weights.

For example, the multi-facial feature combination module 600 is configured to: concatenate the feature Fₑ⁶ to the sub-feature F_{g,r}^{5,k} in the channel dimension, and input a result that is obtained after the feature Fₑ⁶ is concatenated to the sub-feature F_{g,r}^{i,k} into two first preset network modules that are concatenated, to obtain a combined weight wᵣ^{5,k}, where k∈{1, 2, . . . , 10}, and r∈{1, 2, . . . , 5}. The first preset network module includes convolutional layers (Conv), activation layers (ReLU), and downsampling layers (with a downsampling multiple of 4) that are concatenated. First, the sub-feature F_{g,r}^{5,k} and the combined weight wᵣ^{5,k} are multiplied in a dimension of a superscript k, and results of multiplying the feature F_{g,r}^{5,k} and the combined weight wᵣ^{5,k} are added up. Then, a result of the addition in the dimension of the superscript k is multiplied by the first cluster label_1, and results of multiplying the result of the addition in the dimension of the superscript k and the first cluster label_1 are combined in a dimension of a subscript r, to obtain the combined feature \tilde{F}_{g}⁵.

Step 9: With the combined feature \tilde{F}_{g}⁵ as an input for performing convolutional modulation operations on the convolutional neural network module G_32, perform convolutional modulation operations on the convolutional neural network module G_32, the convolutional neural network module G_64, and the convolutional neural network module G_128 sequentially based on a structure of the face restoration network shown in FIG. 10B, to obtain features F_{g}^{11,k} output by the convolutional neural network module G_128, where k∈{1, 2, . . . , 10}.

Step 10: Input the features F_{g}^{11,k} into the multi-facial feature mapping module 500, to obtain sub-features F_{g,r}^{11,k}, where k∈{1, 2, . . . , 10}, and r∈{1, 2, . . . , 5}.

For example, the features F_{g}^{11,k} are divided into five categories of sub-features F_{g,r}^{11,k} in the spatial dimension according to the first cluster label_2, where k∈{1, 2, . . . , 10}, and r∈{1, 2, . . . , 5}.

Step 11: Input the feature Fₑ³ and the sub-features F_{g,r}^{11,k} into the multi-facial feature combination module 600, to obtain a combined feature \tilde{F}_{g}¹¹, where k∈{1, 2, . . . , 10}, and r∈{1, 2, . . . , 5}. It should be understood that the feature Fₑ³ and the sub-features F_{g,r}^{11,k} are of same dimensions.

For example, the multi-facial feature combination module 600 is configured to: concatenate the feature Fₑ³ to the sub-feature F_{g,r}^{11,k} in the spatial dimension; input a result that is obtained after the feature Fₑ³ is concatenated to the sub-feature F_{g,r}^{11,k} into four second preset network modules that are concatenated; and then input an output of a last of the four second preset network modules into a third preset network module, to obtain a combined weight wᵣ^{11,k}, where k∈{1, 2, . . . , 10}, and r∈{1, 2, . . . , 5}. The second preset network module includes convolutional layers (Conv), activation layers (ReLU), and downsampling layers (with a downsampling multiple of 4) that are concatenated. The third preset network module includes convolutional layers (Conv), activation layers (ReLU), and downsampling layers (with a downsampling multiple of 2) that are concatenated. First, the sub-feature F_{g,r}^{11,k} and the combined weight wᵣ^{11,k} are multiplied in a dimension of a superscript k, and results of multiplying the feature F_{g,r}^{11,k} and the combined weight wᵣ^{11,k} are added up. Then, a result of the addition in the dimension of the superscript k is multiplied by the first cluster label_2, and results of multiplying the result of the addition in the dimension of the superscript k and the first cluster label_2 are combined in a dimension of a subscript r, to obtain the combined feature \tilde{F}_{g}¹¹.

Step 12: With the combined feature \tilde{F}_{g}¹¹ as an input for performing convolutional modulation operations on the convolutional neural network module G_256, perform convolutional modulation operations on the convolutional neural network module G_256 and the convolutional neural network module G_512 sequentially based on the structure of the face restoration network shown in FIG. 10B, to output a restored facial image I_{rec}.

A second loss is calculated based on the restored facial image I_{rec} output in step 12. When the second loss is not less than a second preset threshold, a parameter of the face restoration network is adjusted based on the second loss, a training sample is changed, and step 4 to step 12 are repeated until the second loss is less than the second preset threshold. Then, the second training phase ends.

A formula for calculating the second loss is as follows:

$$loss 2 = {‖ {I}_{rec} - GT ‖}_{1} + {λ}_{3} {‖ VGG ( {I}_{rec} ) - VGG ( GT ) ‖}_{1} + {λ}_{4} {‖ log ( 1 - D ( {I}_{rec} ) ) ‖}_{1}$$

In the formula, loss2 represents a second loss, I_{rec} represents a restored facial image, GT represents a truth image, VGG represents a VGG model, D represents a discriminant network or a discriminator, and λ₃ and λ₄ represent weights of loss components.

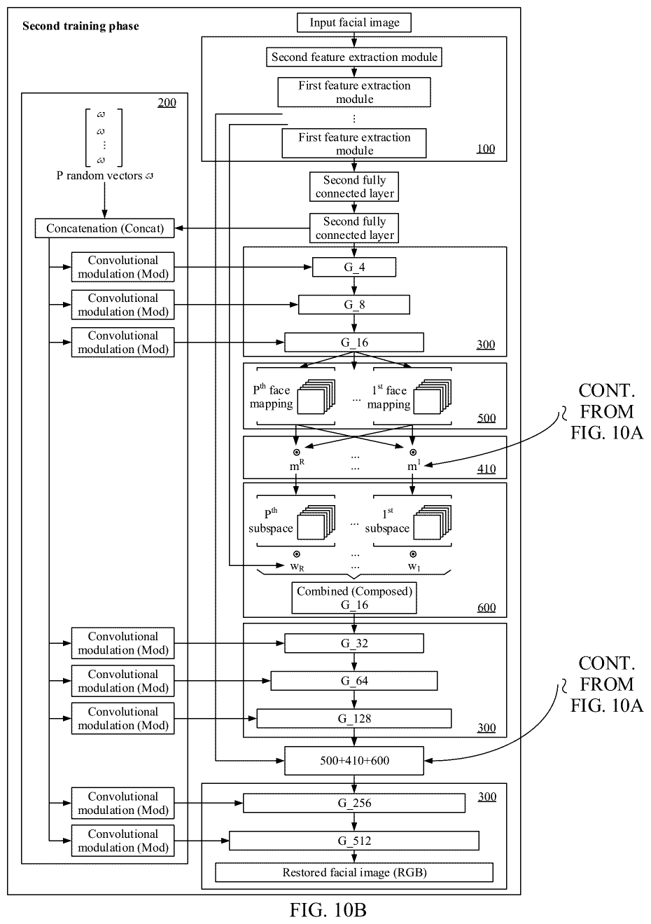

FIG. 11 is a schematic diagram of an inference phase of the face restoration network shown in FIG. 10A and FIG. 10B. The face restoration network can receive a low-quality facial image or a facial image that undergoes complex quality degradation, and can generate a high-quality facial image with rich details, in correct colors, and without artifacts. For example, a low-quality facial image is received, and a high-quality first synthetic facial image is output.

For ease of understanding beneficial effects achieved by an embodiment of this application, the following compares performance of the embodiment of this application with performance of the following seven benchmark algorithms.

Benchmark algorithm 1: ESRGAN method. For details, refer to literature “ESRGAN: Enhanced Super-Resolution Generative Adversarial Networks” in European Conference on Computer Vision (ECCV) 2018.

Benchmark algorithm 2: Deep Face Dictionary Network (DFDNET) method. For details, refer to literature “Blind Face Restoration via Deep Multi-scale Component Dictionaries” in ECCV 2020.

Benchmark algorithm 3: GLEAN method. For details, refer to literature “GLEAN: Generative Latent Bank for Large-Factor Image Super-Resolution” in Conference on Computer Vision and Pattern Recognition (CVPR) 2021.

Benchmark algorithm 4: Generative Facial Prior Generative Adversarial Network (GFPGAN) method. For details, refer to literature “Towards Real-World Blind Face Restoration with Generative Facial Prior” in CVPR 2021.

Benchmark algorithm 5: GPEN method. For details, refer to literature “GAN Prior Embedded Network for Blind Face Restoration in the Wild”.

Benchmark algorithm 6: PULSE method. For details, refer to literature “PULSE: Self-Supervised Photo Upsampling via Latent Space Exploration of Generative Models” in CVPR 2020.

Benchmark algorithm 7: mGANprior method. For details, refer to literature “Image Processing Using Multi-Code GAN Prior” in CVPR 2020.

With a given training set and a given test set, results of a comparison of performance are shown in Table 1.

TABLE 1
Results of a comparison of performance of algorithms

| Algorithm | PSNR | SSIM | LPIPS | NIQE | FID |
|---|---|---|---|---|---|
| ESRGAN | 28.1088 | 0.7808 | 0.3256 | 15.2320 | 68.4088 |
| DFDNET | 26.8188 | 0.7769 | 0.2561 | 9.7146 | 44.6026 |
| GLEAN | 24.5390 | 0.6389 | 0.3378 | 12.9772 | 67.3824 |
| GFPGAN | 26.9351 | 0.7807 | 0.2431 | 11.0229 | 37.7252 |
| GPEN | 26.5649 | 0.7698 | 0.2706 | 11.6622 | 50.1208 |
| PULSE | 21.4504 | 0.5413 | 0.5324 | 13.0708 | 147.6991 |
| mGANprior | 21.3004 | 0.5435 | 0.5381 | 13.4579 | 153.3856 |
| This application | 27.5722 | 0.7872 | 0.2317 | 9.4669 | 36.2616 |

In Table 1, PSNR represents a peak signal-to-noise ratio, SSIM represents structural similarity, LPIPS represents learned perceptual image patch similarity, NIQE represents a natural image quality evaluator, and FID represents a Fréchet inception distance. Experiments indicate that with the test dataset, effect of the method provided in embodiments of this application is significantly better than effect of the seven benchmark methods used for comparison in SSIM, LPIPS, NIQE, and FID. It should be noted that although the PSNR achieved by the ESRGAN method is greater than the PSNR achieved by the method provided in this application, the ESRGAN method causes a face restoration result to be excessively blurry, that is, although the PSNR metric is high, visual effect is reduced.

It should be noted that embodiments of this application are quite widely applied. Embodiments of this application may also be applied to other image restoration or enhancement tasks, for example, building images, home improvement images, and portrait images. The modules in embodiments of this application may also be migrated to other tasks. For example, the facial subspace clustering and division module 400 may be used in face style migration, face editing, and other tasks. For another example, the style vector control module 200 may be used in a facial image repair task. In addition, embodiments of this application are highly robust in real and open scenarios, and can adapt to quality-degraded images that are obtained by mobile phones of different models, obtained in different shooting scenes, transmitted in different ISP pathways, and transmitted in different manners.

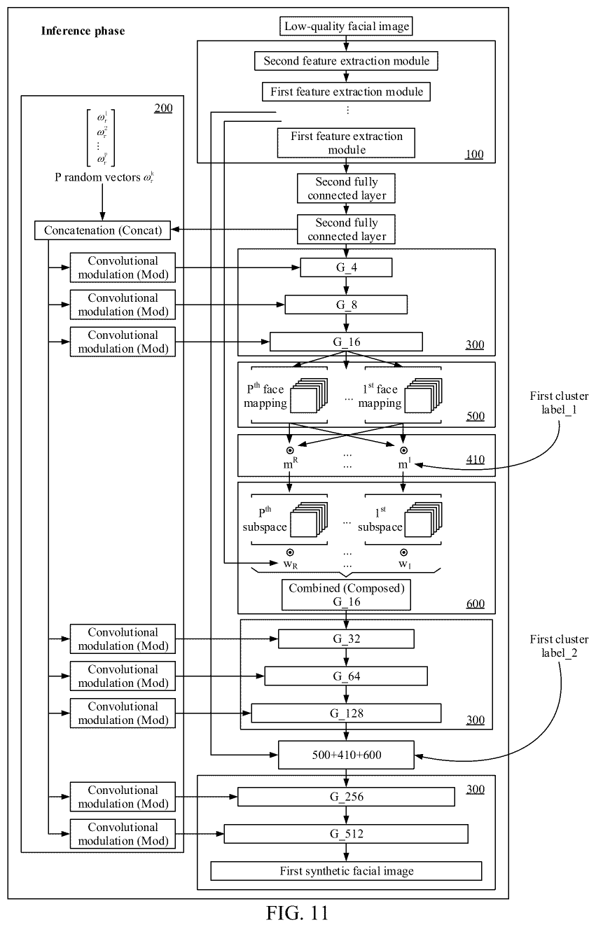

FIG. 12 is a schematic diagram of a structure of a facial image processing apparatus 1200 according to an embodiment of this application. The facial image processing apparatus 1200 is used in an electronic device. The facial image processing apparatus 1200 may include a processing unit 1201 and a communication unit 1202. The processing unit 1201 is configured to perform any step in the method embodiment shown in FIG. 6. When data transmission such as obtaining is performed, the communication unit 1202 may be optionally called to perform a corresponding operation. A detailed description is provided below.

The processing unit 1201 is configured to: obtain a low-quality facial image and a first cluster label; extract features from the low-quality facial image, to obtain a first target facial feature and a second target facial feature; divide each of P third target facial features into R categories of first facial sub-features according to the first cluster label, to obtain P first facial sub-feature sets, where any one of the P first facial sub-feature sets includes R categories of first facial sub-features, P is a positive integer, R is an integer greater than 1, the P third target facial features are an output of a target convolutional neural network module of a face generator, and an input that is of the target convolutional neural network module and that corresponds to the P third target facial features is obtained based on the first target facial feature; combine the first facial sub-features in the P first facial sub-feature sets based on the second target facial feature and the first cluster label, to obtain a first combined facial feature; and obtain a first synthetic facial image based on the first combined facial feature.

In a possible implementation, the P third target facial features are obtained by performing convolutional modulation on the target convolutional neural network module based on the first target facial feature and P first random vectors.

In a possible implementation, the P third target facial features are obtained by performing convolutional modulation on the target convolutional neural network module based on P target style vectors, and the P target style vectors are obtained based on the first target facial feature and the P first random vectors.

In a possible implementation, the P target style vectors are obtained based on P first concatenated vectors, the P first concatenated vectors are obtained by concatenating a first feature vector to each of the P first random vectors, and the first feature vector is obtained based on the first target facial feature.

In a possible implementation, the processing unit 1201 is specifically configured to: obtain P first combined weight sets based on the second target facial feature and the P first facial sub-feature sets, where the P first combined weight sets correspond to the P first facial sub-feature sets, any one of the P first combined weight sets includes R first combined weights, the R first combined weights correspond to R categories of first facial sub-features in a first target facial sub-feature set, the first target facial sub-feature set is a first facial sub-feature set that corresponds to the any first combined weight set and that is of the P first facial sub-feature sets, and any one of the R first combined weights is obtained based on the second target facial feature and a first facial sub-feature that is in a category corresponding to the any first combined weight and that is in the first target facial sub-feature set; and combine the first facial sub-features in the P first facial sub-feature sets based on the first cluster label and the P first combined weight sets, to obtain the first combined facial feature.

In a possible implementation, the processing unit 1201 is specifically configured to: obtain P second facial sub-feature sets based on the P first facial sub-feature sets and the P first combined weight sets, where the P first facial sub-feature sets correspond to the P second facial sub-feature sets, any one of the P second facial sub-feature sets includes R categories of second facial sub-features, the R categories of second facial sub-features correspond to R categories of first facial sub-features in a second target facial sub-feature set, the second target facial sub-feature set is a first facial sub-feature set that corresponds to the any second facial sub-feature set and that is of the P first facial sub-feature sets, a second facial sub-feature in any category of the R categories of second facial sub-features is obtained by multiplying a first target facial sub-feature by a first target combined weight, the first target facial sub-feature is a first facial sub-feature that is in a category corresponding to the any category of second facial sub-features, and the first target combined weight is a first combined weight corresponding to the first target facial sub-feature; add up second facial sub-features that are in a same category in the P second facial sub-feature sets, to obtain R third facial sub-features; multiply the first cluster label by each of the R third facial sub-features, to obtain R fourth facial sub-features; and combine the R fourth facial sub-features, to obtain the first combined facial feature.

In a possible implementation, the first cluster label is obtained by performing one-hot encoding on a second cluster label, the second cluster label is obtained by processing a similarity matrix using a preset clustering method, the similarity matrix is obtained based on a first self-expressive matrix, the first self-expressive matrix is obtained by training a second self-expressive matrix based on a plurality of first facial features, the plurality of first facial features are obtained after a plurality of second random vectors are input into the face generator separately, and the plurality of first facial features are an output of the target convolutional neural network module.

In a possible implementation, the first self-expressive matrix is obtained by performing the following operations, and for the plurality of first facial features, the following operations are performed, to obtain the first self-expressive matrix: S11: multiplying a fourth target facial feature by a first target self-expressive matrix, to obtain a fourth facial feature, where the fourth target facial feature is one of the plurality of first facial features; S12: obtaining a second synthetic facial image based on the fourth facial feature; S13: obtaining a first loss based on the fourth target facial feature and the second synthetic facial image; S14: if the first loss is less than a first preset threshold, using the first target self-expressive matrix as the first self-expressive matrix, or if the first loss is not less than a first preset threshold, adjusting an element in the first target self-expressive matrix based on the first loss to obtain a second target self-expressive matrix, and performing step S15; and S15: continuing to perform step S11 to step S14 with a fifth target facial feature as the fourth target facial feature and the second target self-expressive matrix as the first target self-expressive matrix, where the fifth target facial feature is a first facial feature that is not used for training yet and that is of the plurality of first facial features, and when step S11 is performed for the first time, the first target self-expressive matrix is the second self-expressive matrix.

The facial image processing apparatus 1200 may further include a storage unit 1203, configured to store program code and data of the electronic device. The processing unit 1201 may be a processor. The communication unit 1202 may be a transceiver. The storage unit 1203 may be a memory.

It should be noted that for implementation of each unit, reference may also be correspondingly made to a corresponding description of the method embodiment shown in FIG. 6, and for beneficial effects achieved by the facial image processing apparatus 1200 described in FIG. 12, reference may also be correspondingly made to corresponding descriptions of the method embodiment shown in FIG. 6.

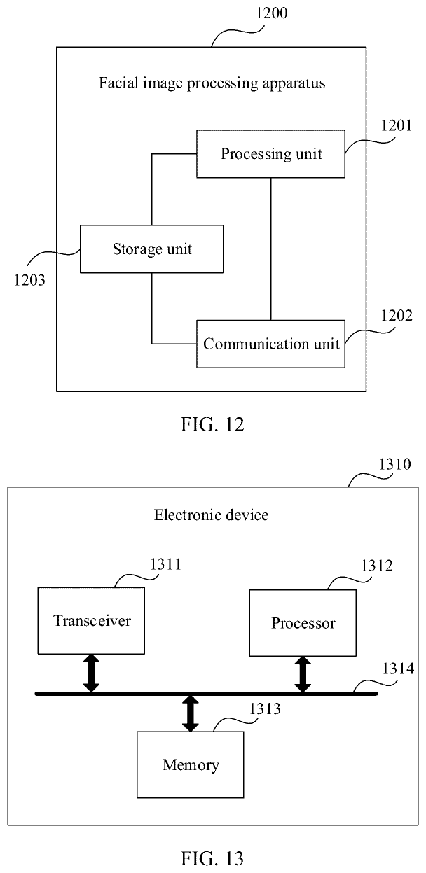

FIG. 13 is a schematic diagram of a structure of an electronic device 1310 according to an embodiment of this application. The electronic device 1310 includes a transceiver 1311, a processor 1312, and a memory 1313. The transceiver 1311, the processor 1312, and the memory 1313 are connected to each other through a bus 1314.

The memory 1313 includes but is not limited to a random access memory (RAM), a read-only memory (ROM), an erasable programmable read only memory (EPROM), or a compact disc read-only memory (CD-ROM). The memory 1313 is configured to store related instructions and data.

The transceiver 1311 is configured to receive and transmit data.

The processor 1312 may be one or more central processing units (CPU). When the processor 1312 is one CPU, the CPU may be a single-core CPU or multi-core CPU.

The processor 1312 in the electronic device 1310 is configured to read program code stored in the memory 1313, to perform the method shown in FIG. 6.

It should be noted that for implementation of each operation, reference may also be correspondingly made to a corresponding description of the embodiment shown in FIG. 6, and for beneficial effects achieved by the electronic device 1310 described in FIG. 13, reference may also be correspondingly made to corresponding descriptions of the method embodiment shown in FIG. 6.

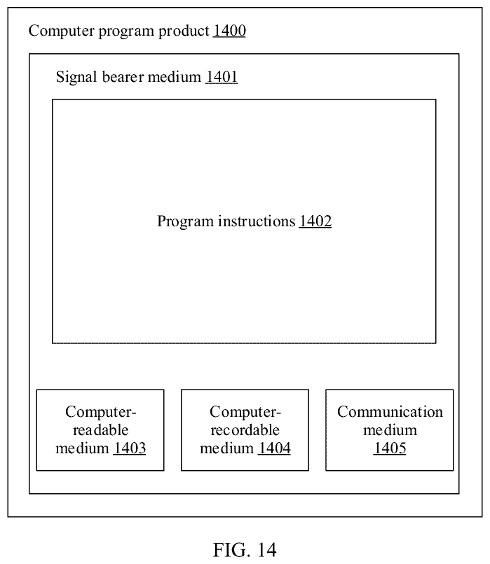

In some embodiments, a disclosed method may be implemented as computer program instructions that are encoded in a computer-readable storage medium or encoded in another non-transitory medium or product in a machine-readable format. FIG. 14 schematically illustrates a conceptual partial view of an example computer program product that is arranged based on at least some embodiments presented herein. The example computer program product includes a computer program used to execute a computer process on a computing device. In an embodiment, an example computer program product 1400 is provided by a signal bearer medium 1401. The signal bearer medium 1401 may include one or more program instructions 1402. When the one or more program instructions 1402 are run by one or more processors, the functions described in FIG. 6 or some of the functions can be provided. Therefore, for example, with reference to the embodiment shown in FIG. 6, one or more features in rectangles 601 to 605 may be borne by one or more instructions associated with the signal bearer medium 1401. In addition, the program instructions 1402 in FIG. 14 also describe example instructions.

In some examples, the signal bearer medium 1401 may include a computer-readable medium 1403, such as but not limited to a hard disk drive, a compact disc (CD), a digital video disc (DVD), a digital tape, a memory, a read-only memory (ROM), or a random access memory (RAM). In some implementations, the signal bearer medium 1401 may include a computer-recordable medium 1404, such as but not limited to a memory, a read/write (R/W) CD, or an R/W DVD. In some implementations, the signal bearer medium 1401 may include a communication medium 1405, such as but not limited to a digital and/or analog communication medium (for example, an optical cable, a waveguide, a wired communication link, or a wireless communication link). Therefore, for example, the signal bearer medium 1401 may be transmitted by the communication medium 1405 that is in a wireless form (for example, a wireless communication medium that complies with the IEEE 802.11 standard or other transmission protocols). The one or more program instructions 1402 may be, for example, computer-executable instructions or logic implementation instructions. In some examples, an electronic device such as the electronic device described in FIG. 13 may be configured to provide various operations, functions, or actions, in response to the program instructions 1402 transmitted to a computing device by one or more of the computer-readable medium 1403, the computer-recordable medium 1404, and/or the communication medium 1405. It should be understood that the arrangement described herein is merely used as an example. Therefore, it may be understood by persons skilled in the art that other arrangements and other elements (for example, machines, interfaces, functions, sequences, and groups of functions) can be used instead, and that some elements may be omitted together based on an expected result. In addition, many of the described elements are functional entities that can be implemented as discrete or distributed components, or implemented in any suitable combination at any suitable position in combination with another component.

An embodiment of this application further provides a chip. The chip includes at least one processor, at least one memory, and at least one interface circuit. The memory, the at least one interface circuit, and the at least one processor are interconnected through a line. The at least one memory stores a computer program. When the computer program is executed by the processor, the method procedure shown in FIG. 6 is implemented.

An embodiment of this application further provides a computer-readable storage medium. The computer-readable storage medium stores a computer program. When the computer program is run on an electronic device, the method procedure shown in FIG. 6 is implemented.

It should be understood that the processor mentioned in embodiments of this application may be a Central Processing Unit (CPU), or may be another general-purpose processor, a Digital Signal Processor (DSP), an Application Specific Integrated Circuit (ASIC), a Field Programmable Gate Array (FPGA), or another programmable logic device, discrete gate or transistor logic device, discrete hardware component, or the like. The general-purpose processor may be a microprocessor, or the processor may be any conventional processor, or the like.

It should be further understood that the memory mentioned in embodiments of this application may be a volatile memory or a nonvolatile memory, or may include both a volatile memory and a nonvolatile memory. The nonvolatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), used as an external cache. Through illustrative but not restrictive descriptions, RAMs in many forms may be used, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM).

It should be noted that when the processor is a general-purpose processor, a DSP, an ASIC, an FPGA, or another programmable logic device, discrete gate or transistor logic device, or discrete hardware component, the memory (a storage module) is integrated in the processor.

It should be noted that the memory described in this specification intends to include, but not limited to, these memories and any other memory of an appropriate type.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

Persons of ordinary skill in the art may be aware that in combination with the examples described in embodiments disclosed in this specification, units and algorithm steps can be implemented by electronic hardware or a combination of computer software and electronic hardware. Whether these functions are performed by hardware or software depends on particular applications and design constraints of the technical solutions. Persons skilled in the art may use different methods to implement the described functions for each particular application, but it should not be considered that the implementation goes beyond the scope of this application.

It may be clearly understood by persons skilled in the art that for the purpose of convenient and brief description, for a specific work process of the system, apparatus, and unit described above, reference may be made to a corresponding process in the foregoing method embodiments. Details are not described herein again.

In the several embodiments provided in this application, it should be understood that the disclosed system, apparatus, and method may be implemented in other manners. For example, the described apparatus embodiments are merely examples. For example, division into the units is merely logical function division. During actual implementation, another division manner may be used. For example, a plurality of units or components may be combined or integrated into another system, or some features may be ignored or may not be performed. In addition, the displayed or discussed mutual couplings or direct couplings or communication connections may be implemented by using some interfaces. The indirect couplings or communication connections between the apparatuses or units may be implemented in an electrical form, a mechanical form, or another form.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions in embodiments.

In addition, functional units in embodiments of this application may be integrated in one processing unit, each of the units may exist alone physically, or two or more units may be integrated in one unit.

When the functions are implemented in a form of a software functional unit and sold or used as an independent product, the functions may be stored in a computer-readable storage medium. Based on such an understanding, the technical solutions of this application essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the method in embodiments of this application. The foregoing storage medium includes any medium that can store program code, such as a USB flash drive, a removable hard disk, a read-only memory (ROM), a random access memory (RAM), a magnetic disc, or a compact disc.

An order of the steps in the method in embodiments of this application may be adjusted, and the steps may be combined and reduced based on an actual requirement. In addition, for terms and explanations in each embodiment of this application, refer to corresponding descriptions in other embodiments.

The modules in the apparatus in embodiments of this application may be combined, divided, and reduced based on an actual requirement.

In conclusion, the foregoing embodiments are merely intended for describing the technical solutions of this application other than limiting the technical solutions of this application. Although this application is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this application.

What is claimed is:

1. A method for processing facial image, comprising:
obtaining a low-quality facial image and a first cluster label;
extracting features from the low-quality facial image to obtain a first target facial feature and a second target facial feature;
dividing each of P third target facial features into R categories of first facial sub-features according to the first cluster label to obtain P first facial sub-feature sets, wherein:
each set of the P first facial sub-feature sets comprises R categories of first facial sub-features, wherein P is a positive integer, and R is an integer greater than 1;
the P third target facial features are an output of a target convolutional neural network module of a face generator; and
an input that is of the target convolutional neural network module and that corresponds to the P third target facial features is obtained based on the first target facial feature;
combining first facial sub-features in the P first facial sub-feature sets based on the second target facial feature and the first cluster label to obtain a first combined facial feature; and
obtaining a first synthetic facial image based on the first combined facial feature.

2. The method according to claim 1, comprising:
obtaining the P third target facial features by performing convolutional modulation on the target convolutional neural network module based on the first target facial feature and P first random vectors.

3. The method according to claim 2, comprising:
obtaining P target style vectors based on the first target facial feature and the P first random vectors; and
obtaining the P third target facial features by performing convolutional modulation on the target convolutional neural network module based on the P target style vectors.

4. The method according to claim 3, comprising:
obtaining a first feature vector based on the first target facial feature;
obtaining P first concatenated vectors by concatenating the first feature vector to each of the P first random vectors, and
obtaining the P target style vectors based on the P first concatenated vectors.

5. The method according to claim 1, wherein the combining the first facial sub-features in the P first facial sub-feature sets based on the second target facial feature and the first cluster label to obtain a first combined facial feature comprises:
obtaining P first combined weight sets based on the second target facial feature and the P first facial sub-feature sets, wherein:
the P first combined weight sets correspond to the P first facial sub-feature sets, wherein each set of the P first combined weight sets comprises R first combined weights;
the R first combined weights correspond to R categories of first facial sub-features in a first target facial sub-feature set;
the first target facial sub-feature set is a first facial sub-feature set that corresponds to a first combined weight set and that is of the P first facial sub-feature sets; and
each one of the R first combined weights is obtained based on the second target facial feature and a first facial sub-feature that is in a category corresponding to the first combined weight and that is in the first target facial sub-feature set; and
combining the first facial sub-features in the P first facial sub-feature sets based on the first cluster label and the P first combined weight sets to obtain the first combined facial feature.

6. The method according to claim 5, wherein the combining the first facial sub-features in the P first facial sub-feature sets based on the first cluster label and the P first combined weight sets, to obtain the first combined facial feature comprises:
obtaining P second facial sub-feature sets based on the P first facial sub-feature sets and the P first combined weight sets, wherein:
the P first facial sub-feature sets correspond to the P second facial sub-feature sets;
each set of the P second facial sub-feature sets comprises R categories of second facial sub-features;
the R categories of second facial sub-features correspond to R categories of first facial sub-features in a second target facial sub-feature set;
the second target facial sub-feature set is a first facial sub-feature set that corresponds to a second facial sub-feature set and that is of the P first facial sub-feature sets;
a second facial sub-feature in each category of the R categories of second facial sub-features is obtained by multiplying a first target facial sub-feature by a first target combined weight;
the first target facial sub-feature is a first facial sub-feature that is in a category corresponding to a category of second facial sub-features; and
the first target combined weight is a first combined weight corresponding to the first target facial sub-feature;
adding up second facial sub-features that are in a same category in the P second facial sub-feature sets to obtain R third facial sub-features;
multiplying the first cluster label by each of the R third facial sub-features to obtain R fourth facial sub-features; and
combining the R fourth facial sub-features to obtain the first combined facial feature.

7. The method according to claim 1, comprising:
obtaining a plurality of first facial features by inputting a plurality of second random vectors into the face generator separately, wherein the plurality of first facial features are an output of the target convolutional neural network module;
obtaining a first self-expressive matrix by training a second self-expressive matrix based on the plurality of first facial features;
obtaining a similarity matrix based on the first self-expressive matrix;
obtaining a second cluster label by processing the similarity matrix using a preset clustering method; and
obtaining the first cluster label by performing one-hot encoding on the second cluster label.

8. The method according to claim 7, wherein obtaining the first self-expressive matrix by training the second self-expressive matrix based on the plurality of first facial features comprises:
multiplying a fourth target facial feature by a first target self-expressive matrix to obtain a fourth facial feature, wherein the fourth target facial feature is one of the plurality of first facial features;
obtaining a second synthetic facial image based on the fourth facial feature;
obtaining a first loss based on the fourth target facial feature and the second synthetic facial image;
in response to determining that the first loss is less than a first preset threshold, determining the first target self-expressive matrix as the first self-expressive matrix; or in response to determining that the first loss is not less than a first preset threshold, adjusting an element in the first target self-expressive matrix based on the first loss to obtain a second target self-expressive matrix;
multiplying a fifth target facial feature by a second target self-expressive matrix to obtain a fifth facial feature, wherein the fifth target facial feature is a first facial feature that is not used for training yet and that is of the plurality of first facial features;
obtaining a third synthetic facial image based on the fifth facial feature;
obtaining a second loss based on the fifth target facial feature and the third synthetic facial image; and
in response to determining that the second loss is less than the first preset threshold, determining the second target self-expressive matrix as the second self-expressive matrix; or in response to determining that the second less is not less than the first preset threshold, adjusting an element in the second target self-expressive matrix based on the second loss to obtain a third target self-expressive matrix;
wherein when the step of multiplying the fourth target facial feature by the first target self-expressive matrix to obtain the fourth facial feature is performed for the first time, the first target self-expressive matrix is the second self-expressive matrix.

9. An apparatus for facial image processing, wherein the apparatus comprises:
one or more processors; and
one or more memories coupled to the one or more processors and storing programming instructions for execution by the one or more processors to:
obtain a low-quality facial image and a first cluster label;
extract features from the low-quality facial image, to obtain a first target facial feature and a second target facial feature;
divide each of P third target facial features into R categories of first facial sub-features according to the first cluster label to obtain P first facial sub-feature sets, wherein:
each set of the P first facial sub-feature sets comprises R categories of first facial sub-features, wherein P is a positive integer, and R is an integer greater than 1;
the P third target facial features are an output of a target convolutional neural network module of a face generator; and
an input that is of the target convolutional neural network module and that corresponds to the P third target facial features is obtained based on the first target facial feature;
combine first facial sub-features in the P first facial sub-feature sets based on the second target facial feature and the first cluster label to obtain a first combined facial feature; and
obtain a first synthetic facial image based on the first combined facial feature.

10. The apparatus according to claim 9, wherein the one or more memories store programming instructions for execution by the one or more processors to:
obtain the P third target facial features by performing convolutional modulation on the target convolutional neural network module based on the first target facial feature and P first random vectors.

11. The apparatus according to claim 10, wherein the one or more memories store programming instructions for execution by the one or more processors to:
obtain the P third target facial features by performing convolutional modulation on the target convolutional neural network module based on P target style vectors, and the P target style vectors are obtained based on the first target facial feature and the P first random vectors.

12. The apparatus according to claim 11, wherein the one or more memories store programming instructions for execution by the one or more processors to:
obtain a first feature vector based on the first target facial feature;
obtain P first concatenated vectors by concatenating the first feature vector to each of the P first random vectors; and
obtain the P target style vectors based on the P first concatenated vectors.

13. The apparatus according to claim 9, wherein the combine first facial sub-features in the P first facial sub-feature sets based on the second target facial feature and the first cluster label to obtain a first combined facial feature comprises:
obtain P first combined weight sets based on the second target facial feature and the P first facial sub-feature sets, wherein:
the P first combined weight sets correspond to the P first facial sub-feature sets, wherein each set of the P first combined weight sets comprises R first combined weights;
the R first combined weights correspond to R categories of first facial sub-features in a first target facial sub-feature set,
the first target facial sub-feature set is a first facial sub-feature set that corresponds to a first combined weight set and that is of the P first facial sub-feature sets, and
each one of the R first combined weights is obtained based on the second target facial feature and a first facial sub-feature that is in a category corresponding to the first combined weight and that is in the first target facial sub-feature set; and
combine the first facial sub-features in the P first facial sub-feature sets based on the first cluster label and the P first combined weight sets, to obtain the first combined facial feature.

14. The apparatus according to claim 13, wherein the combine first facial sub-features in the P first facial sub-feature sets based on the second target facial feature and the first cluster label to obtain a first combined facial feature comprises:
obtain P second facial sub-feature sets based on the P first facial sub-feature sets and the P first combined weight sets, wherein:
the P first facial sub-feature sets correspond to the P second facial sub-feature sets;
each set of the P second facial sub-feature sets comprises R categories of second facial sub-features;
the R categories of second facial sub-features correspond to R categories of first facial sub-features in a second target facial sub-feature set;
the second target facial sub-feature set is a first facial sub-feature set that corresponds to a second facial sub-feature set and that is of the P first facial sub-feature sets;
a second facial sub-feature in each category of the R categories of second facial sub-features is obtained by multiplying a first target facial sub-feature by a first target combined weight;
the first target facial sub-feature is a first facial sub-feature that is in a category corresponding to a category of second facial sub-features; and
the first target combined weight is a first combined weight corresponding to the first target facial sub-feature;
add up second facial sub-features that are in a same category in the P second facial sub-feature sets to obtain R third facial sub-features;
multiply the first cluster label by each of the R third facial sub-features, to obtain R fourth facial sub-features; and
combine the R fourth facial sub-features to obtain the first combined facial feature.

15. The apparatus according to claim 9, wherein the one or more memories store programming instructions for execution by the one or more processors to:
obtain a plurality of first facial features by inputting a plurality of second random vectors into the face generator separately, wherein the plurality of first facial features are an output of the target convolutional neural network module;
obtain a first self-expressive matrix by training a second self-expressive matrix based on the plurality of first facial features;
obtain a similarity matrix based on the first self-expressive matrix;
obtain a second cluster label by processing the similarity matrix using a preset clustering method; and
obtain the first cluster label by performing one-hot encoding on the second cluster label.

16. The apparatus according to claim 15, wherein the obtain the first self-expressive matrix by training the second self-expressive matrix based on the plurality of first facial features comprises:
multiply a fourth target facial feature by a first target self-expressive matrix, to obtain a fourth facial feature, wherein the fourth target facial feature is one of the plurality of first facial features;
obtain a second synthetic facial image based on the fourth facial feature;
obtain a first loss based on the fourth target facial feature and the second synthetic facial image;
in response to determining that the first loss is less than a first preset threshold, determine the first target self-expressive matrix as the first self-expressive matrix; or in response to determining that the first loss is not less than a first preset threshold, adjust an element in the first target self-expressive matrix based on the first loss to obtain a second target self-expressive matrix; and
multiply a fifth target facial feature by a second target self-expressive matrix to obtain a fifth facial feature, wherein the fifth target facial feature is a first facial feature that is not used for training yet and that is of the plurality of first facial features;
obtain a third synthetic facial image based on the fifth facial feature;
obtain a second loss based on the fifth target facial feature and the third synthetic facial image; and
in response to determining that the second loss is less than the first preset threshold, determine the second target self-expressive matrix as the second self-expressive matrix; or in response to determining that the second less is not less than the first preset threshold, adjust an element in the second target self-expressive matrix based on the second loss to obtain a third target self-expressive matrix;
wherein when the step of multiplying the fourth target facial feature by the first target self-expressive matrix to obtain the fourth facial feature is performed for the first time, the first target self-expressive matrix is the second self-expressive matrix.

17. A non-transitory computer-readable storage medium storing computer-executable instructions for execution by one or more processors of an apparatus to:
obtain a low-quality facial image and a first cluster label;
extract features from the low-quality facial image to obtain a first target facial feature and a second target facial feature;
divide each of P third target facial features into R categories of first facial sub-features according to the first cluster label, to obtain P first facial sub-feature sets, wherein:
each set of the P first facial sub-feature sets comprises R categories of first facial sub-features, wherein P is a positive integer, and R is an integer greater than 1;
the P third target facial features are an output of a target convolutional neural network module of a face generator; and
an input that is of the target convolutional neural network module and that corresponds to the P third target facial features is obtained based on the first target facial feature;
combine first facial sub-features in the P first facial sub-feature sets based on the second target facial feature and the first cluster label, to obtain a first combined facial feature; and
obtain a first synthetic facial image based on the first combined facial feature.

18. The non-transitory computer-readable storage medium according to claim 17, wherein the non-transitory computer-readable storage medium stores computer-executable instructions for execution by the one or more processors to:
obtain P third target facial features by performing convolutional modulation on the target convolutional neural network module based on the first target facial feature and P first random vectors.

19. The non-transitory computer-readable storage medium according to claim 18, wherein the non-transitory computer-readable storage medium stores computer-executable instructions for execution by the one or more processors to:
obtain P target style vectors based on the first target facial feature and the P first random vectors; and
obtain the P third target facial features by performing convolutional modulation on the target convolutional neural network module based on the P target style vectors.

20. The non-transitory computer-readable storage medium according to claim 19, wherein the non-transitory computer-readable storage medium stores computer-executable instructions for execution by the one or more processors to:
obtain a first feature vector based on the first target facial feature;
obtain P first concatenated vectors by concatenating the first feature vector to each of the P first random vectors, and
obtain the P target style vectors based on the P first concatenated vectors.
